(19) United States
(12) Patent Application Publication
(10) Pub. No.: US 2023/0358868 A1
(43) Pub. Date: Nov. 9, 2023

(54) Mitigating Crosstalk from High-Intensity Returns in a Light Detection and Ranging (Lidar) Device

(71) Applicant: Waymo LLC, Mountain View, CA (US)

(72) Inventor: Georges Goetz, Mountain View, CA (US)

(21) Appl. No.: 17/662,239

(22) Filed: May 6, 2022

(51) Int. Cl. G01S 7/497; G01S 17/894; G01S 17/931; G01S 7/48; G01S 7/481; G01S 7/4865

(52) U.S. Cl. CPC G01S 7/497; G01S 17/894; G01S 17/931; G01S 7/4808; G01S 7/4811; G01S 7/4865

(57) ABSTRACT

Example embodiments relate to mitigating crosstalk from high-intensity returns in a light detection and ranging (lidar) device. An example embodiment includes a lidar device. The lidar device includes an array of channels. Each channel includes a light detector and a corresponding light emitter. The lidar device also includes a controller. The controller is configured to cause one or more of the light emitters to emit light pulses. The controller is also configured to determine, based on a reflection pulse, that a high-reflectivity surface is present in a surrounding environment and a distance between the lidar device and the high-reflectivity surface. Additionally, the controller is configured to determine which of the other light detectors within the array of channels are susceptible to crosstalk from the first channel. Further, the controller is configured to identify one or more detected pulses that represent crosstalk from the first channel.

### BACKGROUND

Unless otherwise indicated herein, the description in this section is not prior art to the claims in this application and is not admitted to be prior art by inclusion in this section.

Autonomous vehicles or vehicles operating in an autonomous mode may use various sensors to detect their surroundings. For example, light detection and ranging (lidar) devices, radio detection and ranging (radar) devices, and/or cameras may be used to identify objects in environments surrounding autonomous vehicles. Such sensors may be used in object detection and avoidance and/or in navigation, for example.

A lidar device can determine distances to environmental features while scanning a scene. Those distances can then be assembled into a “point cloud” indicative of surfaces in the environment. Individual points in the point cloud can be determined, for example, by transmitting a laser pulse and detecting a returning pulse, if any, reflected from an object in the environment, and then determining a distance to the object according to a time delay between the transmission of the pulse and the reception of the reflected pulse. The resulting point cloud, for example, may correspond to a three-dimensional map of points indicative of locations of reflective features in the environment.

### SUMMARY

Lidar devices may include multiple channels (e.g., each channel including one or more light emitters and one or more corresponding light detectors) used to perform detection of a field of view of a surrounding environment. Such channels, though, may be susceptible to crosstalk (i.e., when the emission/detection process being performed by one channel adversely affects the emission/detection process being performed by another channel). Further, crosstalk may be exacerbated (e.g., may affect more channels and/or may affect channels in a stronger fashion) when high-intensity returns occur (e.g., as a result of a highly reflective surface in the surrounding environment). Example embodiments described herein provide a method of mitigating the crosstalk occurring within the lidar device based on the physical layout of the channels within the lidar device and the distance to surfaces in the surrounding environment. Using the position of channels within the lidar device and the transit time to surfaces in the surrounding environment, detection events within channels of the lidar device can be classified as constituting crosstalk. When such detection events are classified as crosstalk, they can be removed such that they are not incorporated into data representing the surrounding environment (e.g., such that they are excluded from a point cloud that is generated to represent the surrounding environment).

In a first aspect, a light detection and ranging (lidar) device is provided. The lidar device includes an array of channels. Each channel includes a light detector and a corresponding light emitter. The lidar device also includes a controller. The controller is configured to cause one or more of the light emitters in the array of channels to emit light pulses. The controller is also configured to determine, based on a reflection pulse detected by a first light detector of a first channel in the array of channels, that a high-reflectivity surface is present in a surrounding environment and a distance between the lidar device and the high-reflectivity surface. Additionally, the controller is configured to determine, based on: (i) a position of the first light detector, (ii) positions of other light detectors within the array of channels, and (iii) the distance between the lidar device and the high-reflectivity surface, which of the other light detectors within the array of channels are susceptible to crosstalk from the first channel. Further, the controller is configured to identify one or more detected pulses that represent crosstalk from the first channel. The one or more detected pulses that represent crosstalk are associated with the light detectors susceptible to crosstalk and are identified based on the distance between the lidar device and the high-reflectivity surface. In addition, the controller is configured to prevent the one or more detected pulses that represent crosstalk from the first channel from being included in a dataset usable to generate a point cloud.

In a second aspect, a method is provided. The method includes emitting, from a first light emitter of a light detection and ranging (lidar) device, a light pulse. The lidar device includes an array of channels and a controller. A first channel of the array of channels includes the first light emitter and a corresponding first light detector. The method also includes detecting, by the first light detector, a reflection pulse. Additionally, the method includes determining, by the controller based on the reflection pulse, that a high-reflectivity surface is present in a surrounding environment and a distance between the lidar device and the high-reflectivity surface. Further, the method includes determining, by the controller based on: (i) a position of the first light detector, (ii) positions of other light detectors within the array of channels, and (iii) the distance between the lidar device and the high-reflectivity surface, which of the other light detectors within the array of channels are susceptible to crosstalk from the first channel. In addition, the method includes identifying, by the controller based on the distance between the lidar device and the high-reflectivity surface, one or more detected pulses that represent crosstalk from the first channel. The one or more detected pulses that represent crosstalk are associated with the light detectors susceptible to crosstalk. Still further, the method includes preventing, by the controller, one or more detected pulses that represent crosstalk from the first channel from being included in a dataset usable to generate a point cloud.

In a third aspect, a system is provided. The system includes a computing device configured to generate a point cloud from a dataset usable to generate the point cloud. The system also includes a light detection and ranging (lidar) device. The lidar device includes an array of channels. Each channel includes a light detector and a corresponding light emitter. The lidar device also includes a controller. The controller is configured to cause one or more of the light emitters in the array of channels to emit light pulses. The controller is also configured to determine, based on a reflection pulse detected by a first light detector of a first channel in the array of channels, that a high-reflectivity surface is present in a surrounding environment and a distance between the lidar device and the high-reflectivity surface. Additionally, the controller is configured to determine, based on: (i) a position of the first light detector, (ii) positions of other light detectors within the array of channels, and (iii) the distance between the lidar device and the high-reflectivity surface, which of the other light detectors within the array of channels are susceptible to crosstalk from the first channel. Further, the controller is configured to identify one or more detected pulses that represent crosstalk from the first channel. The one or more detected pulses that represent crosstalk are associated with the light detectors susceptible to crosstalk and are identified based on the distance between the lidar device and the high-reflectivity surface. In addition, the controller is configured to prevent the one or more detected pulses that represent crosstalk from the first channel from being included in the dataset usable to generate the point cloud. Still further, the controller is configured to transmit, to the computing device, the dataset usable to generate the point cloud.

These as well as other aspects, advantages, and alternatives will become apparent to those of ordinary skill in the art by reading the following detailed description, with reference, where appropriate, to the accompanying drawings.

### BRIEF DESCRIPTION OF THE DRAWINGS

FIG. 1 is a functional block diagram illustrating a vehicle, according to example embodiments.

FIG. 2A is an illustration of a physical configuration of a vehicle, according to example embodiments.

FIG. 2B is an illustration of a physical configuration of a vehicle, according to example embodiments.

FIG. 2C is an illustration of a physical configuration of a vehicle, according to example embodiments.

FIG. 2D is an illustration of a physical configuration of a vehicle, according to example embodiments.

FIG. 2E is an illustration of a physical configuration of a vehicle, according to example embodiments.

FIG. 2F is an illustration of a physical configuration of a vehicle, according to example embodiments.

FIG. 2G is an illustration of a physical configuration of a vehicle, according to example embodiments.

FIG. 2H is an illustration of a physical configuration of a vehicle, according to example embodiments.

FIG. 2I is an illustration of a physical configuration of a vehicle, according to example embodiments.

FIG. 2J is an illustration of a field of view for various sensors, according to example embodiments.

FIG. 2K is an illustration of beam steering for a sensor, according to example embodiments.

FIG. 3 is a conceptual illustration of wireless communication between various computing systems related to an autonomous or semi-autonomous vehicle, according to example embodiments.

FIG. 4A is a block diagram of a system including a lidar device, according to example embodiments.

FIG. 4B is a block diagram of a lidar device, according to example embodiments.

FIG. 5 is an illustration of an array of channels within a lidar device, according to example embodiments.

FIG. 6 is an illustration of crosstalk between channels within a lidar device, according to example embodiments.

FIG. 7A is an illustration of the dependence of crosstalk between channels within a lidar device on distance, according to example embodiments.

FIG. 7B is an illustration of the dependence of crosstalk between channels within a lidar device on distance, according to example embodiments.

FIG. 8 is an illustration of a lookup table, according to example embodiments.

FIG. 9A is an illustration of an emission sequence, according to example embodiments.

FIG. 9B is an illustration of a detection sequence, according to example embodiments.

FIG. 9C is an illustration of a detection sequence, according to example embodiments.

FIG. 9D is an illustration of a detection sequence, according to example embodiments.

FIG. 10 is an illustration of a technique for preventing one or more crosstalk pulses from being included in a dataset usable to generate a point cloud, according to example embodiments.

FIG. 11 is a flowchart illustration of a method, according to example embodiments.

### DETAILED DESCRIPTION

Example methods and systems are contemplated herein. Any example embodiment or feature described herein is not necessarily to be construed as preferred or advantageous over other embodiments or features. Further, the example embodiments described herein are not meant to be limiting. It will be readily understood that certain aspects of the disclosed systems and methods can be arranged and combined in a wide variety of different configurations, all of which are contemplated herein. In addition, the particular arrangements shown in the figures should not be viewed as limiting. It should be understood that other embodiments might include more or less of each element shown in a given figure. Additionally, some of the illustrated elements may be combined or omitted. Yet further, an example embodiment may include elements that are not illustrated in the figures.

Lidar devices as described herein can include one or more light emitters and one or more detectors used for detecting light that is emitted by the one or more light emitters and reflected by one or more objects in an environment surrounding the lidar device. As an example, the surrounding environment could include an interior or exterior environment, such as an inside of a building or an outside of a building. Additionally or alternatively, the surrounding environment could include an interior of a vehicle. Still further, the surrounding environment could include a vicinity around and/or on a roadway. Examples of objects in the surrounding environment include, but are not limited to, other vehicles, traffic signs, pedestrians, bicyclists, roadway surfaces, buildings, terrain, etc. Additionally, the one or more light emitters could emit light into a local environment of the lidar itself. For example, light emitted from the one or more light emitters could interact with a housing of the lidar and/or surfaces or structures coupled to the lidar. In some cases, the lidar could be mounted to a vehicle, in which case the one or more light emitters could be configured to emit light that interacts with objects within a vicinity of the vehicle. Further, the light emitters could include optical fiber amplifiers, laser diodes, light-emitting diodes (LEDs), among other possibilities.

In example embodiments, lidar devices may include one or more light emitters (e.g., laser diodes) and one or more light detectors (e.g., silicon photomultipliers (SiPMs), single-photon avalanche diodes (SPADs), APDs, etc.). For example, a lidar device may include an array of channels (each of which including one or more light detectors and one or more corresponding light emitters). Such arrays may illuminate objects in the scene and receive reflected light from objects in the scene so as to collect data that may be used to generate a point cloud for a particular angular field of view relative to the lidar device. Further, to generate a point cloud with an enhanced field of view (e.g., a complete 360° field of view), the array of light emitters and the corresponding array of light detectors may send and receive light at predetermined times and/or locations within that enhanced field of view. For example, the lidar device may include an array of channels arranged around the vertical axis such that light is transmitted and received in multiple directions around the 360° field of view simultaneously. As another example, a lidar device may scan (e.g., be rotated or use other mechanisms to beam scan) about a central axis to transmit/receive multiple sets of data. The data can be used to form point clouds that can be composited to generate the enhanced field of view.

Some lidar devices may be susceptible to noise resulting from high-intensity return signals. For example, if one light emitter emits a light pulse toward a highly reflective object (e.g., a retroreflector), the return pulse from that object may have a high intensity. In some cases, if the intensity of the return pulse is large enough, the return pulse may result in crosstalk between channels of the lidar device. In other words, in addition to being detected by the light detector corresponding to the light emitter that emitted the emission pulse, the high-intensity return pulse may be detected by other light detectors within the lidar device (e.g., light detectors adjacent to the light detector corresponding to the light emitter that emitted the emission pulse). Such crosstalk can result in detection errors. For example, when a light detector detects a return pulse that is the result of crosstalk, a computing device associated with the lidar device may improperly determine that an object is present at a location within the surrounding environment even though, in reality, no such object is present (i.e., the lidar device may generate false positive detections). Additionally or alternatively, as a result of detecting the high-intensity crosstalk return pulse, a proper return pulse (e.g., at a lower intensity) may be improperly overlooked. As such, example embodiments disclosed herein may serve to mitigate and/or eliminate improper detections arising from noise sources. While crosstalk resulting from highly reflective objects is referenced throughout this disclosure, it is understood that other sources of noise are also possible and could also be mitigated using the techniques described herein.

In some embodiments, a lidar device is provided. As described above, the lidar device may include an array of channels. Each of the channels in the array may include a light detector and a corresponding light emitter. For example, the light emitter in a given channel may be configured to emit light pulses along a certain emission vector and the corresponding light detector may be configured to detect light pulses reflected from objects in the surrounding environment that are in the path of the emission vector. Each of the light detectors in different channels of the array of channels may be positioned near one another in the lidar device in an array of light detectors. As such, any high-intensity return pulses may influence light detectors that are nearby the primary light detector that detects the high-intensity return pulse.

One way to mitigate such crosstalk is to identify which channel in the array of channels has an emission vector that intersects the high-reflectivity object in the surrounding environment that causes the high-intensity return. Then, upon identifying the channel that is the source of the crosstalk, the light emitter in that channel can simply refrain from emitting light pulses in future emission cycles. It may be difficult, however, to determine when (e.g., in which emission cycle) to once again resume emitting light pulses from the light emitter that corresponded to the high-intensity reflection. Likewise, another possible mitigation technique would be to simply disregard any detected pulses in future detection cycles that are detected by light detectors in the array that are nearby the primary light detector that detected the high-intensity reflection. This may result in a number of channels being essentially unused during one or more detection cycles, though. As is evident, the above mitigation strategies may result in multiple detected pulses being disregarded, perhaps unnecessarily.

As such, described herein are alternative noise mitigation techniques. Namely, the techniques described herein may identify and eliminate detected pulses that are due to crosstalk without indefinitely deactivating a light emitter that might be causing the crosstalk and without disregarding all the detected signals in adjacent channels. In some embodiments, mitigating the crosstalk effects of high-intensity detected pulses may include the following.

First, a controller of the lidar device may determine which detected pulses, if any, represent a high-intensity return corresponding to a high-reflectivity surface in the surrounding environment. This may be done by the controller comparing the intensity of each of the detected pulses to a threshold intensity. In addition to identifying a possible high-intensity detected pulse, the controller may determine a distance between the lidar device (or, specifically, the respective channel in the lidar device that detected the high-intensity detected pulse) and the high-reflectivity surface.

Then, the controller may determine which other channels within the array of channels are susceptible to being influenced by high-intensity returns on the channel that detected the high-intensity detected pulse (i.e., which channels are susceptible to potential crosstalk). Determining which channels within the array of channels are susceptible to crosstalk may be based on a number of factors, such as the location within the array of channels of the light detector that detected the high-intensity detected pulse, the location of the other light detectors within the array of channels (e.g., the distance between the light detector that detected the high-intensity detected pulse and the other light detectors in the array), the distance between the lidar device and the high-reflectivity surface, and the intensity of the high-intensity detected signal (e.g., the greater the intensity of the high-intensity detected signal, the more likely that crosstalk arising from that signal will be above the detection threshold of adjacent light detectors). Making this determination may involve the controller making use of a previously determined lookup table (e.g., a lookup table that is stored in memory). For example, the lookup table could have a list of potentially affected light detectors for each combination of: (i) channel responsible for the crosstalk and (ii) set of potential distances between the lidar device and the high-reflectivity object. In some embodiments, the lookup table may also account for the intensity of the detected high-intensity return pulse. Further, in some embodiments, the lookup table may also be determined based on a pitch angle of and/or a yaw angle of emission vectors associated with the light emitters within the various channels of the lidar device. The lookup table may be calculated prior to run-time and stored within a non-transitory, computer-readable medium, for example.

Next, the controller may analyze pulses that are detected by light detectors within channels that are identified as being susceptible to crosstalk. Based on this analysis, the controller may determine which of the detected pulses in those channels actually do represent crosstalk and which do not. In some embodiments, this determination may be based on the detection times associated with the detected pulses. For example, if a light detector is determined as being susceptible to crosstalk and detects a return pulse that would correspond to a detection distance that is roughly equal to the distance to the high-reflectivity surface, it may be determined that such a detected pulse corresponds to crosstalk, rather than a proper detection event.

In some embodiments, an even more sophisticated process may be performed to determine which detected pulses correspond to crosstalk detection events. For example, upon determining which channel detected the pulse corresponding to the high-reflectivity surface, the controller may cause the light emitter of that channel to emit a series of pulses according to a predefined firing sequence. For instance, the predefined firing sequence may include a series of five emission periods during which the controller: causes the light emitter to refrain from emitting a light pulse, causes the light emitter to emit a light pulse, causes the light emitter to refrain from emitting a light pulse, causes the light emitter to refrain from emitting a light pulse, and causes the light emitter to emit a light pulse. Other predefined firing sequences are also possible and are contemplated herein. In addition to causing the light emitter of the channel corresponding to the high-reflectivity surface to emit light pulses according to a predefined firing sequence, the controller may also analyze the detection events from light detectors susceptible to crosstalk during the corresponding detection time periods. By comparing detection events (or lack thereof) corresponding to emission periods when the light emitter corresponding to the high-reflectivity is emitting and when it is refraining from emitting, the controller can more readily determine whether detection events of nearby light detectors are caused by crosstalk. This additional sophisticated process may provide further robustness against false negatives (e.g., identifying a detected pulse as crosstalk rather than a proper pulse), especially for non-crosstalk detected pulses that correspond to environmental objects that are at roughly the same distance from the lidar device as the high-reflectivity surface.

Regardless of how crosstalk detection events are identified, upon identification, the crosstalk detection events may be prevented from being included in a dataset that is usable to generate a point cloud based on the lidar data. For example, the controller may transmit a datastream that represents the detected pulses to another computing device (e.g., a central computing device of an autonomous or semi-autonomous vehicle or a server computing device) so that the other computing device can assemble the detected pulses into a point cloud. As such, the controller may refrain from including the detected pulses that correspond to crosstalk detection events in the datastream. In embodiments that use a predefined firing sequence to perform further disambiguation (as described above), the controller (e.g., implemented as a field-programmable gate array (FPGA)) may include a memory (e.g., a random-access memory (RAM)) used to buffer detection events for a duration equal to the length of the predefined firing sequence so that crosstalk events can be analyzed/removed from the datastream prior to being transmitted to an additional computing device.

Additionally or alternatively, the controller may store a dataset corresponding to detection events within a memory associated with the controller (e.g., a cloud memory storage or a non-transitory, computer-readable medium onboard the controller or onboard the associated vehicle). In such embodiments, the controller may refrain from including the detection events that correspond to crosstalk detection events within the dataset and/or may remove detection events that correspond to crosstalk detection events from the dataset if the dataset is already stored in the associated memory. In still other embodiments, the controller, itself, may generate a point cloud. As such, the controller may refrain from including points in the point cloud that correspond to crosstalk detection events.

In this way, adverse effects that may otherwise arise due to crosstalk detection events (e.g., improper control decisions with respect to navigation or object avoidance) may be effectively negated. Similarly, using the techniques described herein, detection events that occur on the same channels as the crosstalk detection events but do not correspond to crosstalk detection events may be maintained and used.

The following description and accompanying drawings will elucidate features of various example embodiments. The embodiments provided are by way of example, and are not intended to be limiting. As such, the dimensions of the drawings are not necessarily to scale.

Example systems within the scope of the present disclosure will now be described in greater detail. An example system may be implemented in or may take the form of an automobile. Additionally, an example system may also be implemented in or take the form of various vehicles, such as cars, trucks (e.g., pickup trucks, vans, tractors, tractor trailers, etc.), motorcycles, buses, airplanes, helicopters, drones, lawn mowers, earth movers, boats, submarines, all-terrain vehicles, snowmobiles, aircraft, recreational vehicles, amusement park vehicles, farm equipment or vehicles, construction equipment or vehicles, warehouse equipment or vehicles, factory equipment or vehicles, trams, golf carts, trains, trolleys, sidewalk delivery vehicles, robot devices, etc. Other vehicles are possible as well. Further, in some embodiments, example systems might not include a vehicle.

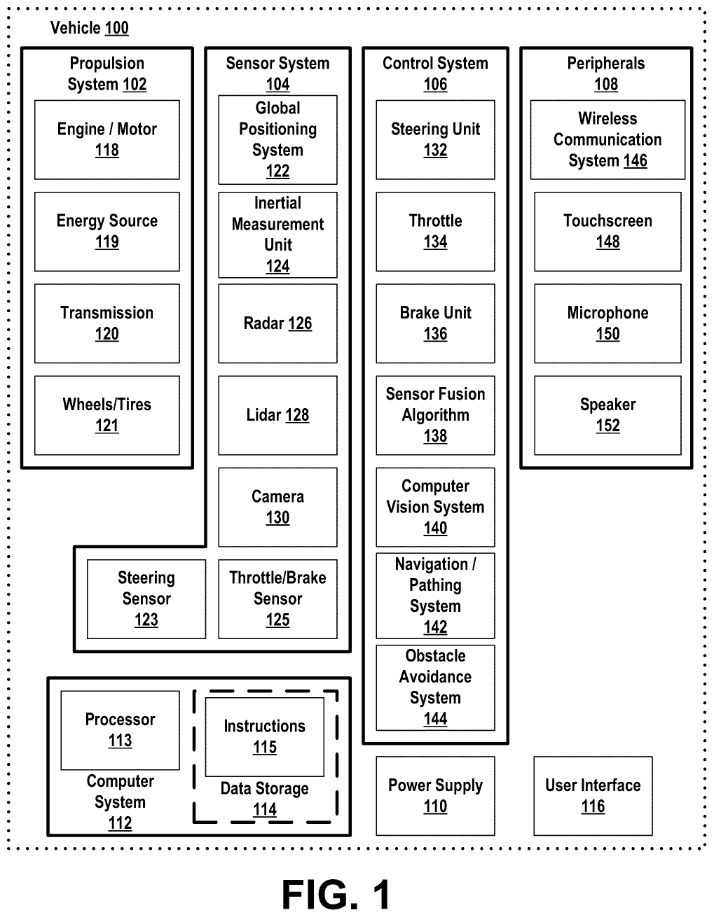

Referring now to the figures, FIG. 1 is a functional block diagram illustrating example vehicle 100, which may be configured to operate fully or partially in an autonomous mode. More specifically, vehicle 100 may operate in an autonomous mode without human interaction through receiving control instructions from a computing system. As part of operating in the autonomous mode, vehicle 100 may use sensors to detect and possibly identify objects of the surrounding environment to enable safe navigation. Additionally, example vehicle 100 may operate in a partially autonomous (i.e., semi-autonomous) mode in which some functions of the vehicle 100 are controlled by a human driver of the vehicle 100 and some functions of the vehicle 100 are controlled by the computing system. For example, vehicle 100 may also include subsystems that enable the driver to control operations of vehicle 100 such as steering, acceleration, and braking, while the computing system performs assistive functions such as lane-departure warnings/lane-keeping assist or adaptive cruise control based on other objects (e.g., vehicles, etc.) in the surrounding environment.

As described herein, in a partially autonomous driving mode, even though the vehicle assists with one or more driving operations (e.g., steering, braking and/or accelerating to perform lane centering, adaptive cruise control, advanced driver assistance systems (ADAS), emergency braking, etc.), the human driver is expected to be situationally aware of the vehicle's surroundings and supervise the assisted driving operations. Here, even though the vehicle may perform all driving tasks in certain situations, the human driver is expected to be responsible for taking control as needed.

Although, for brevity and conciseness, various systems and methods are described below in conjunction with autonomous vehicles, these or similar systems and methods can be used in various driver assistance systems that do not rise to the level of fully autonomous driving systems (i.e. partially autonomous driving systems). In the United States, the Society of Automotive Engineers (SAE) have defined different levels of automated driving operations to indicate how much, or how little, a vehicle controls the driving, although different organizations, in the United States or in other countries, may categorize the levels differently. More specifically, the disclosed systems and methods can be used in SAE Level 2 driver assistance systems that implement steering, braking, acceleration, lane centering, adaptive cruise control, etc., as well as other driver support. The disclosed systems and methods can be used in SAE Level 3 driving assistance systems capable of autonomous driving under limited (e.g., highway, etc.) conditions. Likewise, the disclosed systems and methods can be used in vehicles that use SAE Level 4 self-driving systems that operate autonomously under most regular driving situations and require only occasional attention of the human operator. In all such systems, accurate lane estimation can be performed automatically without a driver input or control (e.g., while the vehicle is in motion, etc.) and result in improved reliability of vehicle positioning and navigation and the overall safety of autonomous, semi-autonomous, and other driver assistance systems. As previously noted, in addition to the way in which SAE categorizes levels of automated driving operations, other organizations, in the United States or in other countries, may categorize levels of automated driving operations differently. Without limitation, the disclosed systems and methods herein can be used in driving assistance systems defined by these other organizations' levels of automated driving operations.

As shown in FIG. 1, vehicle 100 may include various subsystems, such as propulsion system 102, sensor system 104, control system 106, one or more peripherals 108, power supply 110, computer system 112 (which could also be referred to as a computing system) with data storage 114, and user interface 116. In other examples, vehicle 100 may include more or fewer subsystems, which can each include multiple elements. The subsystems and components of vehicle 100 may be interconnected in various ways. In addition, functions of vehicle 100 described herein can be divided into additional functional or physical components, or combined into fewer functional or physical components within embodiments. For instance, the control system 106 and the computer system 112 may be combined into a single system that operates the vehicle 100 in accordance with various operations.

Propulsion system 102 may include one or more components operable to provide powered motion for vehicle 100 and can include an engine/motor 118, an energy source 119, a transmission 120, and wheels/tires 121, among other possible components. For example, engine/motor 118 may be configured to convert energy source 119 into mechanical energy and can correspond to one or a combination of an internal combustion engine, an electric motor, steam engine, or Stirling engine, among other possible options. For instance, in some embodiments, propulsion system 102 may include multiple types of engines and/or motors, such as a gasoline engine and an electric motor.

Energy source 119 represents a source of energy that may, in full or in part, power one or more systems of vehicle 100 (e.g., engine/motor 118, etc.). For instance, energy source 119 can correspond to gasoline, diesel, other petroleum-based fuels, propane, other compressed gas-based fuels, ethanol, solar panels, batteries, and/or other sources of electrical power. In some embodiments, energy source 119 may include a combination of fuel tanks, batteries, capacitors, and/or flywheels.

Transmission 120 may transmit mechanical power from engine/motor 118 to wheels/tires 121 and/or other possible systems of vehicle 100. As such, transmission 120 may include a gearbox, a clutch, a differential, and a drive shaft, among other possible components. A drive shaft may include axles that connect to one or more wheels/tires 121.

Wheels/tires 121 of vehicle 100 may have various configurations within example embodiments. For instance, vehicle 100 may exist in a unicycle, bicycle/motorcycle, tricycle, or car/truck four-wheel format, among other possible configurations. As such, wheels/tires 121 may connect to vehicle 100 in various ways and can exist in different materials, such as metal and rubber.

Sensor system 104 can include various types of sensors, such as Global Positioning System (GPS) 122, inertial measurement unit (IMU) 124, radar 126, lidar 128, camera 130, steering sensor 123, and throttle/brake sensor 125, among other possible sensors. In some embodiments, sensor system 104 may also include sensors configured to monitor internal systems of the vehicle 100 (e.g., 02 monitor, fuel gauge, engine oil temperature, brake wear, etc.).

GPS 122 may include a transceiver operable to provide information regarding the position of vehicle 100 with respect to the Earth. IMU 124 may have a configuration that uses one or more accelerometers and/or gyroscopes and may sense position and orientation changes of vehicle 100 based on inertial acceleration. For example, IMU 124 may detect a pitch and yaw of the vehicle 100 while vehicle 100 is stationary or in motion.

Radar 126 may represent one or more systems configured to use radio signals to sense objects, including the speed and heading of the objects, within the surrounding environment of vehicle 100. As such, radar 126 may include antennas configured to transmit and receive radio signals. In some embodiments, radar 126 may correspond to a mountable radar configured to obtain measurements of the surrounding environment of vehicle 100.

Lidar 128 may include one or more laser sources, a laser scanner, and one or more detectors, among other system components, and may operate in a coherent mode (e.g., using heterodyne detection, etc.) or in an incoherent detection mode (i.e., time-of-flight mode). In some embodiments, the one or more detectors of the lidar 128 may include one or more photodetectors, which may be especially sensitive detectors (e.g., avalanche photodiodes, etc.). In some examples, such photodetectors may be capable of detecting single photons (e.g., single-photon avalanche diodes (SPADs), etc.). Further, such photodetectors can be arranged (e.g., through an electrical connection in series, etc.) into an array (e.g., as in a silicon photomultiplier (SiPM), etc.). In some examples, the one or more photodetectors are Geiger-mode operated devices and the lidar includes subcomponents designed for such Geiger-mode operation.

Camera 130 may include one or more devices (e.g., still camera, video camera, a thermal imaging camera, a stereo camera, a night vision camera, etc.) configured to capture images of the surrounding environment of vehicle 100.

Steering sensor 123 may sense a steering angle of vehicle 100, which may involve measuring an angle of the steering wheel or measuring an electrical signal representative of the angle of the steering wheel. In some embodiments, steering sensor 123 may measure an angle of the wheels of the vehicle 100, such as detecting an angle of the wheels with respect to a forward axis of the vehicle 100. Steering sensor 123 may also be configured to measure a combination (or a subset) of the angle of the steering wheel, electrical signal representing the angle of the steering wheel, and the angle of the wheels of vehicle 100.

Throttle/brake sensor 125 may detect the position of either the throttle position or brake position of vehicle 100. For instance, throttle/brake sensor 125 may measure the angle of both the gas pedal (throttle) and brake pedal or may measure an electrical signal that could represent, for instance, an angle of a gas pedal (throttle) and/or an angle of a brake pedal. Throttle/brake sensor 125 may also measure an angle of a throttle body of vehicle 100, which may include part of the physical mechanism that provides modulation of energy source 119 to engine/motor 118 (e.g., a butterfly valve, a carburetor, etc.). Additionally, throttle/brake sensor 125 may measure a pressure of one or more brake pads on a rotor of vehicle 100 or a combination (or a subset) of the angle of the gas pedal (throttle) and brake pedal, electrical signal representing the angle of the gas pedal (throttle) and brake pedal, the angle of the throttle body, and the pressure that at least one brake pad is applying to a rotor of vehicle 100. In other embodiments, throttle/brake sensor 125 may be configured to measure a pressure applied to a pedal of the vehicle, such as a throttle or brake pedal.

Control system 106 may include components configured to assist in navigating vehicle 100, such as steering unit 132, throttle 134, brake unit 136, sensor fusion algorithm 138, computer vision system 140, navigation/pathing system 142, and obstacle avoidance system 144. More specifically, steering unit 132 may be operable to adjust the heading of vehicle 100, and throttle 134 may control the operating speed of engine/motor 118 to control the acceleration of vehicle 100. Brake unit 136 may decelerate vehicle 100, which may involve using friction to decelerate wheels/tires 121. In some embodiments, brake unit 136 may convert kinetic energy of wheels/tires 121 to electric current for subsequent use by a system or systems of vehicle 100.

Sensor fusion algorithm 138 may include a Kalman filter, Bayesian network, or other algorithms that can process data from sensor system 104. In some embodiments, sensor fusion algorithm 138 may provide assessments based on incoming sensor data, such as evaluations of individual objects and/or features, evaluations of a particular situation, and/or evaluations of potential impacts within a given situation.

Computer vision system 140 may include hardware and software (e.g., a general purpose processor such as a central processing unit (CPU), a specialized processor such as a graphical processing unit (GPU) or a tensor processing unit (TPU), an application-specific integrated circuit (ASIC), a field programmable gate array (FPGA), a volatile memory, a non-volatile memory, one or more machine-learned models, etc.) operable to process and analyze images in an effort to determine objects that are in motion (e.g., other vehicles, pedestrians, bicyclists, animals, etc.) and objects that are not in motion (e.g., traffic lights, roadway boundaries, speedbumps, potholes, etc.). As such, computer vision system 140 may use object recognition, Structure From Motion (SFM), video tracking, and other algorithms used in computer vision, for instance, to recognize objects, map an environment, track objects, estimate the speed of objects, etc.

Navigation/pathing system 142 may determine a driving path for vehicle 100, which may involve dynamically adjusting navigation during operation. As such, navigation/pathing system 142 may use data from sensor fusion algorithm 138, GPS 122, and maps, among other sources to navigate vehicle 100. Obstacle avoidance system 144 may evaluate potential obstacles based on sensor data and cause systems of vehicle 100 to avoid or otherwise negotiate the potential obstacles.

As shown in FIG. 1, vehicle 100 may also include peripherals 108, such as wireless communication system 146, touchscreen 148, interior microphone 150, and/or speaker 152. Peripherals 108 may provide controls or other elements for a user to interact with user interface 116. For example, touchscreen 148 may provide information to users of vehicle 100. User interface 116 may also accept input from the user via touchscreen 148. Peripherals 108 may also enable vehicle 100 to communicate with devices, such as other vehicle devices.

Wireless communication system 146 may wirelessly communicate with one or more devices directly or via a communication network. For example, wireless communication system 146 could use 3G cellular communication, such as code-division multiple access (CDMA), evolution-data optimized (EVDO), global system for mobile communications (GSM)/general packet radio service (GPRS), or cellular communication, such as 4G worldwide interoperability for microwave access (WiMAX) or long-term evolution (LTE), or 5G. Alternatively, wireless communication system 146 may communicate with a wireless local area network (WLAN) using WIFI® or other possible connections. Wireless communication system 146 may also communicate directly with a device using an infrared link, Bluetooth, or ZigBee, for example. Other wireless protocols, such as various vehicular communication systems, are possible within the context of the disclosure. For example, wireless communication system 146 may include one or more dedicated short-range communications (DSRC) devices that could include public and/or private data communications between vehicles and/or roadside stations.

Vehicle 100 may include power supply 110 for powering components. Power supply 110 may include a rechargeable lithium-ion or lead-acid battery in some embodiments. For instance, power supply 110 may include one or more batteries configured to provide electrical power. Vehicle 100 may also use other types of power supplies. In an example embodiment, power supply 110 and energy source 119 may be integrated into a single energy source.

Vehicle 100 may also include computer system 112 to perform operations, such as operations described therein. As such, computer system 112 may include at least one processor 113 (which could include at least one microprocessor) operable to execute instructions 115 stored in a non-transitory, computer-readable medium, such as data storage 114. In some embodiments, computer system 112 may represent a plurality of computing devices that may serve to control individual components or subsystems of vehicle 100 in a distributed fashion.

In some embodiments, data storage 114 may contain instructions 115 (e.g., program logic, etc.) executable by processor 113 to execute various functions of vehicle 100, including those described above in connection with FIG. 1. Data storage 114 may contain additional instructions as well, including instructions to transmit data to, receive data from, interact with, and/or control one or more of propulsion system 102, sensor system 104, control system 106, and peripherals 108.

In addition to instructions 115, data storage 114 may store data such as roadway maps, path information, among other information. Such information may be used by vehicle 100 and computer system 112 during the operation of vehicle 100 in the autonomous, semi-autonomous, and/or manual modes.

Vehicle 100 may include user interface 116 for providing information to or receiving input from a user of vehicle 100. User interface 116 may control or enable control of content and/or the layout of interactive images that could be displayed on touchscreen 148. Further, user interface 116 could include one or more input/output devices within the set of peripherals 108, such as wireless communication system 146, touchscreen 148, microphone 150, and speaker 152.

Computer system 112 may control the function of vehicle 100 based on inputs received from various subsystems (e.g., propulsion system 102, sensor system 104, control system 106, etc.), as well as from user interface 116. For example, computer system 112 may utilize input from sensor system 104 in order to estimate the output produced by propulsion system 102 and control system 106. Depending upon the embodiment, computer system 112 could be operable to monitor many aspects of vehicle 100 and its subsystems. In some embodiments, computer system 112 may disable some or all functions of the vehicle 100 based on signals received from sensor system 104.

The components of vehicle 100 could be configured to work in an interconnected fashion with other components within or outside their respective systems. For instance, in an example embodiment, camera 130 could capture a plurality of images that could represent information about a state of a surrounding environment of vehicle 100 operating in an autonomous or semi-autonomous mode. The state of the surrounding environment could include parameters of the road on which the vehicle is operating. For example, computer vision system 140 may be able to recognize the slope (grade) or other features based on the plurality of images of a roadway. Additionally, the combination of GPS 122 and the features recognized by computer vision system 140 may be used with map data stored in data storage 114 to determine specific road parameters. Further, radar 126 and/or lidar 128, and/or some other environmental mapping, ranging, and/or positioning sensor system may also provide information about the surroundings of the vehicle.

In other words, a combination of various sensors (which could be termed input-indication and output-indication sensors) and computer system 112 could interact to provide an indication of an input provided to control a vehicle or an indication of the surroundings of a vehicle.

In some embodiments, computer system 112 may make a determination about various objects based on data that is provided by systems other than the radio system. For example, vehicle 100 may have lasers or other optical sensors configured to sense objects in a field of view of the vehicle. Computer system 112 may use the outputs from the various sensors to determine information about objects in a field of view of the vehicle, and may determine distance and direction information to the various objects. Computer system 112 may also determine whether objects are desirable or undesirable based on the outputs from the various sensors.

Although FIG. 1 shows various components of vehicle 100 (i.e., wireless communication system 146, computer system 112, data storage 114, and user interface 116) as being integrated into the vehicle 100, one or more of these components could be mounted or associated separately from vehicle 100. For example, data storage 114 could, in part or in full, exist separate from vehicle 100. Thus, vehicle 100 could be provided in the form of device elements that may be located separately or together. The device elements that make up vehicle 100 could be communicatively coupled together in a wired and/or wireless fashion.

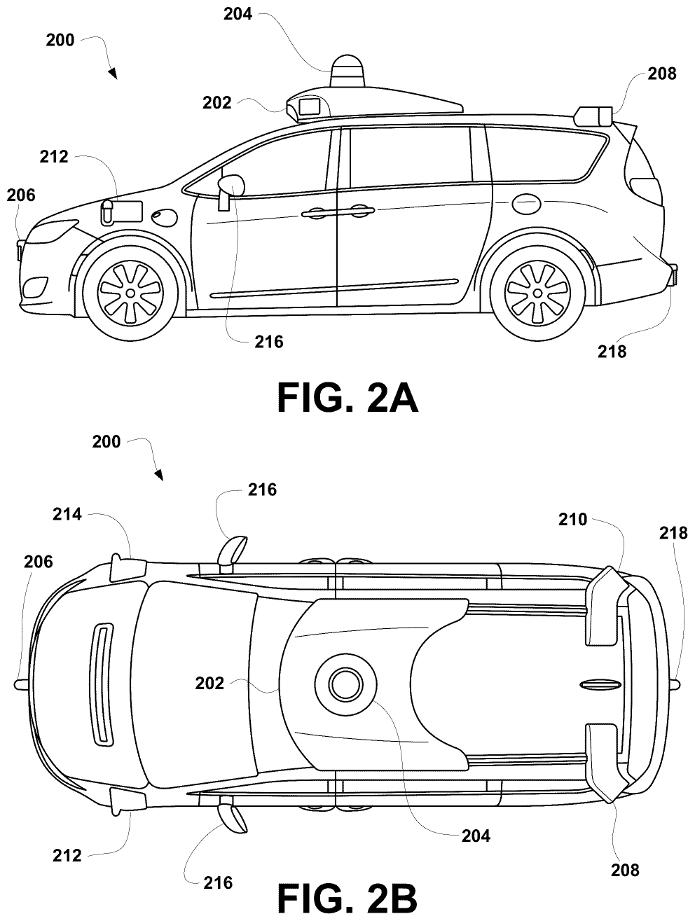

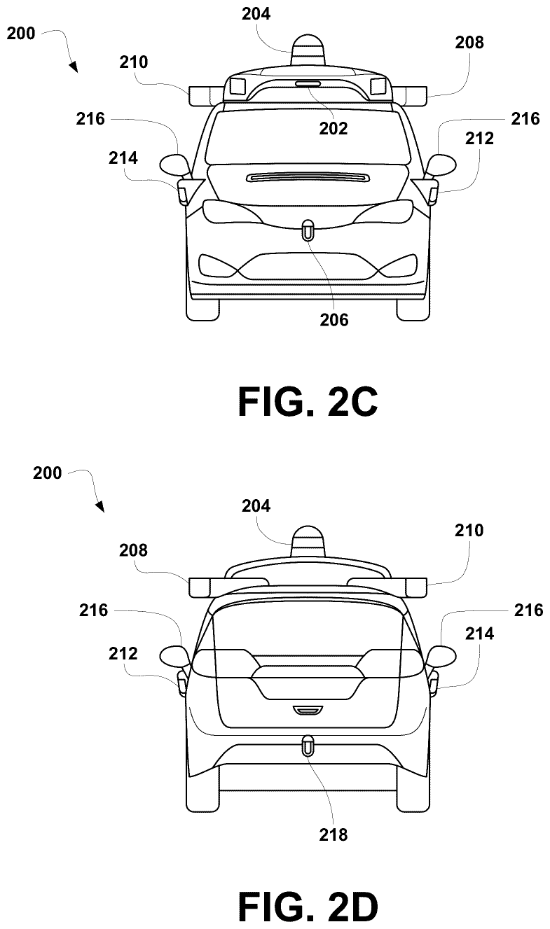

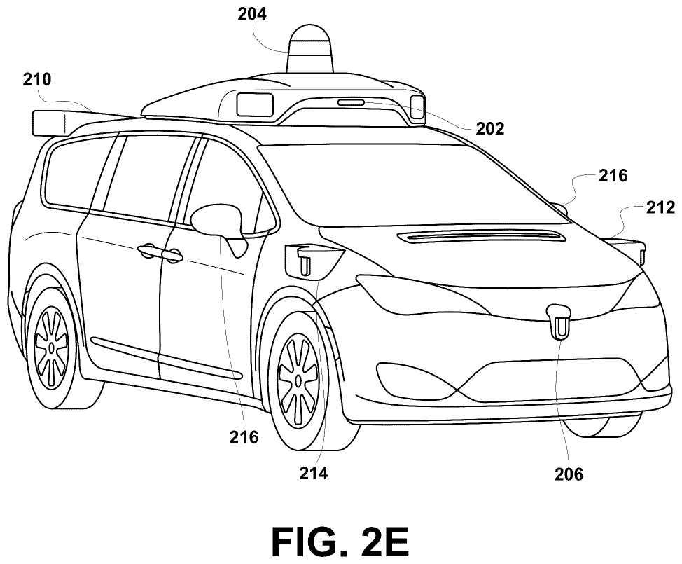

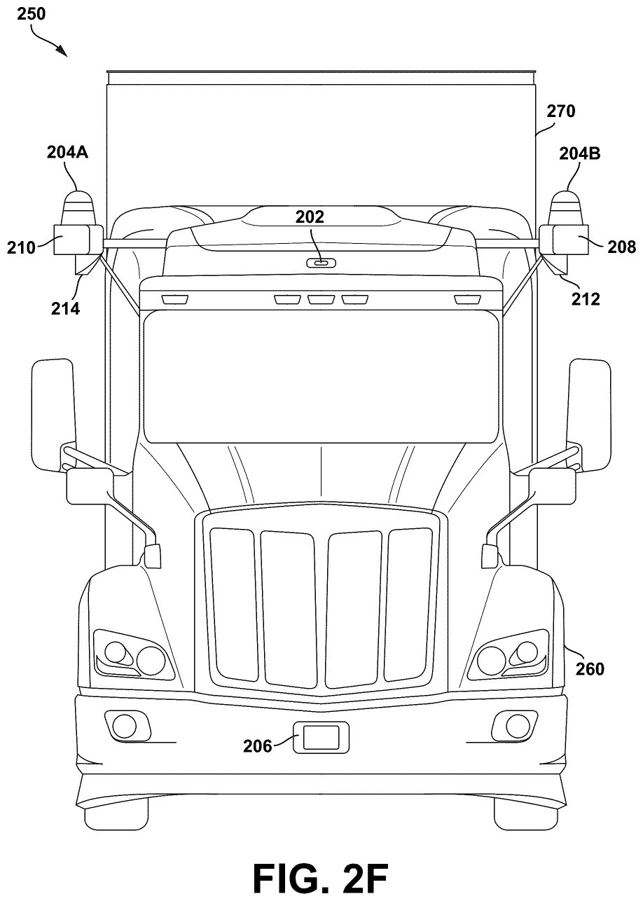

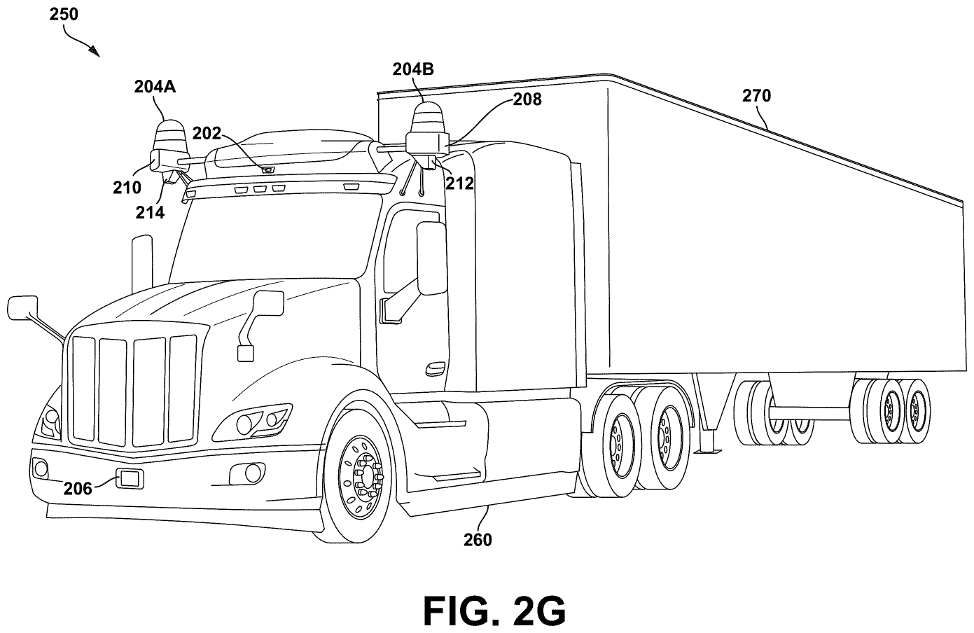

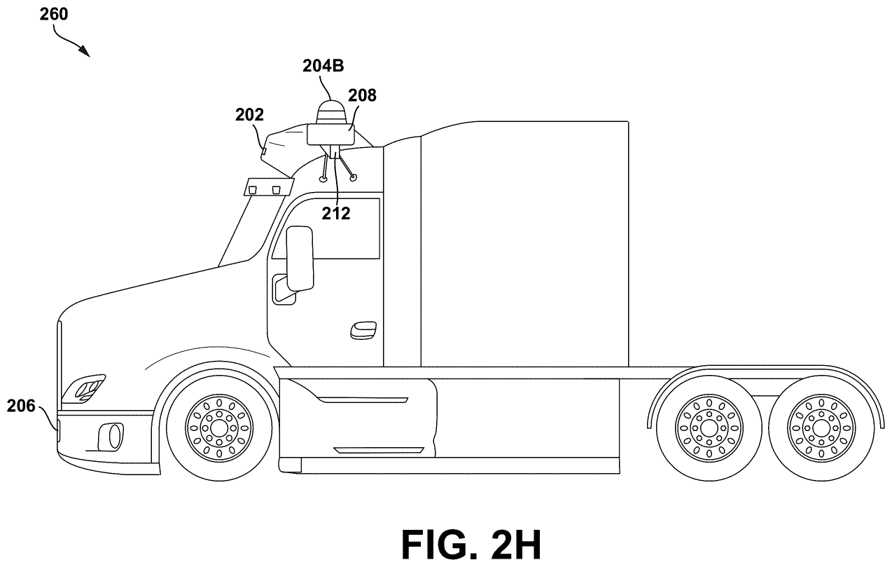

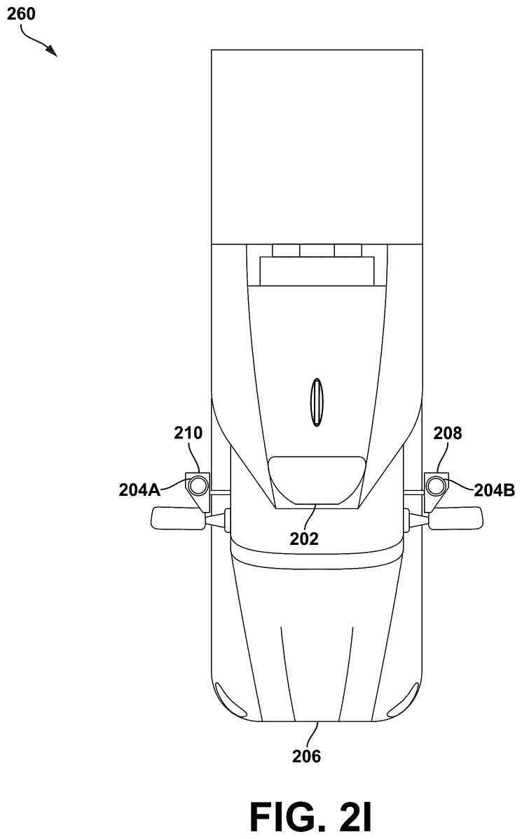

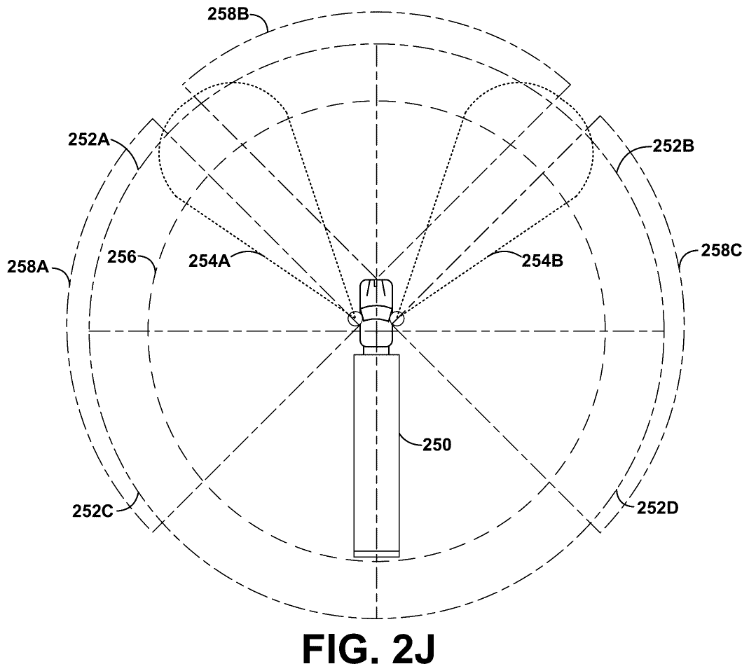

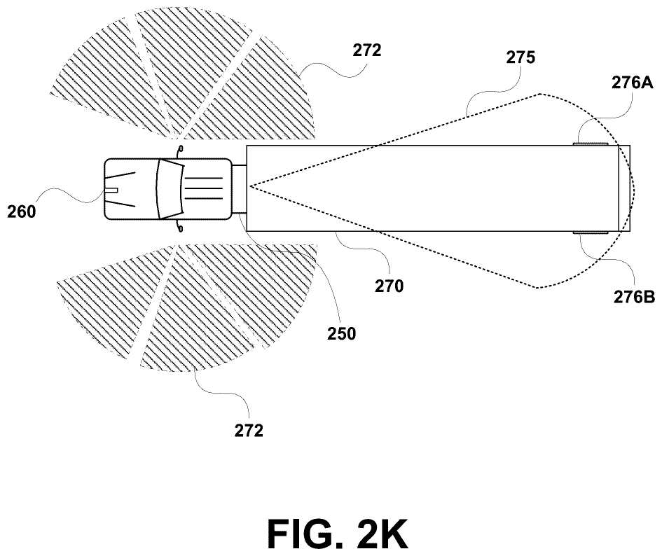

FIGS. 2A-2E show an example vehicle 200 (e.g., a fully autonomous vehicle or semi-autonomous vehicle, etc.) that can include some or all of the functions described in connection with vehicle 100 in reference to FIG. 1. Although vehicle 200 is illustrated in FIGS. 2A-2E as a van with side view mirrors for illustrative purposes, the present disclosure is not so limited. For instance, the vehicle 200 can represent a truck, a car, a semi-trailer truck, a motorcycle, a golf cart, an off-road vehicle, a farm vehicle, or any other vehicle that is described elsewhere herein (e.g., buses, boats, airplanes, helicopters, drones, lawn mowers, earth movers, submarines, all-terrain vehicles, snowmobiles, aircraft, recreational vehicles, amusement park vehicles, farm equipment, construction equipment or vehicles, warehouse equipment or vehicles, factory equipment or vehicles, trams, trains, trolleys, sidewalk delivery vehicles, and robot devices, etc.).

The example vehicle 200 may include one or more sensor systems 202, 204, 206, 208, 210, 212, 214, and 218. In some embodiments, sensor systems 202, 204, 206, 208, 210, 212, 214, and/or 218 could represent one or more optical systems (e.g. cameras, etc.), one or more lidars, one or more radars, one or more inertial sensors, one or more humidity sensors, one or more acoustic sensors (e.g., microphones, sonar devices, etc.), or one or more other sensors configured to sense information about an environment surrounding the vehicle 200. In other words, any sensor system now known or later created could be coupled to the vehicle 200 and/or could be utilized in conjunction with various operations of the vehicle 200. As an example, a lidar could be utilized in self-driving or other types of navigation, planning, perception, and/or mapping operations of the vehicle 200. In addition, sensor systems 202, 204, 206, 208, 210, 212, 214, and/or 218 could represent a combination of sensors described herein (e.g., one or more lidars and radars; one or more lidars and cameras; one or more cameras and radars; one or more lidars, cameras, and radars; etc.).

Note that the number, location, and type of sensor systems (e.g., 202, 204, etc.) depicted in FIGS. 2A-E are intended as a non-limiting example of the location, number, and type of such sensor systems of an autonomous or semi-autonomous vehicle. Alternative numbers, locations, types, and configurations of such sensors are possible (e.g., to comport with vehicle size, shape, aerodynamics, fuel economy, aesthetics, or other conditions, to reduce cost, to adapt to specialized environmental or application circumstances, etc.). For example, the sensor systems (e.g., 202, 204, etc.) could be disposed in various other locations on the vehicle (e.g., at location 216, etc.) and could have fields of view that correspond to internal and/or surrounding environments of the vehicle 200.

The sensor system 202 may be mounted atop the vehicle 200 and may include one or more sensors configured to detect information about an environment surrounding the vehicle 200, and output indications of the information. For example, sensor system 202 can include any combination of cameras, radars, lidars, inertial sensors, humidity sensors, and acoustic sensors (e.g., microphones, sonar devices, etc.). The sensor system 202 can include one or more movable mounts that could be operable to adjust the orientation of one or more sensors in the sensor system 202. In one embodiment, the movable mount could include a rotating platform that could scan sensors so as to obtain information from each direction around the vehicle 200. In another embodiment, the movable mount of the sensor system 202 could be movable in a scanning fashion within a particular range of angles and/or azimuths and/or elevations. The sensor system 202 could be mounted atop the roof of a car, although other mounting locations are possible.

Additionally, the sensors of sensor system 202 could be distributed in different locations and need not be collocated in a single location. Furthermore, each sensor of sensor system 202 can be configured to be moved or scanned independently of other sensors of sensor system 202. Additionally or alternatively, multiple sensors may be mounted at one or more of the sensor locations 202, 204, 206, 208, 210, 212, 214, and/or 218. For example, there may be two lidar devices mounted at a sensor location and/or there may be one lidar device and one radar mounted at a sensor location.

The one or more sensor systems 202, 204, 206, 208, 210, 212, 214, and/or 218 could include one or more lidar sensors. For example, the lidar sensors could include a plurality of light-emitter devices arranged over a range of angles with respect to a given plane (e.g., the x-y plane, etc.). For example, one or more of the sensor systems 202, 204, 206, 208, 210, 212, 214, and/or 218 may be configured to rotate or pivot about an axis (e.g., the z-axis, etc.) perpendicular to the given plane so as to illuminate an environment surrounding the vehicle 200 with light pulses. Based on detecting various aspects of reflected light pulses (e.g., the elapsed time of flight, polarization, intensity, etc.), information about the surrounding environment may be determined.

In an example embodiment, sensor systems 202, 204, 206, 208, 210, 212, 214, and/or 218 may be configured to provide respective point cloud information that may relate to physical objects within the surrounding environment of the vehicle 200. While vehicle 200 and sensor systems 202, 204, 206, 208, 210, 212, 214, and 218 are illustrated as including certain features, it will be understood that other types of sensor systems are contemplated within the scope of the present disclosure. Further, the example vehicle 200 can include any of the components described in connection with vehicle 100 of FIG. 1.

In an example configuration, one or more radars can be located on vehicle 200. Similar to radar 126 described above, the one or more radars may include antennas configured to transmit and receive radio waves (e.g., electromagnetic waves having frequencies between 30 Hz and 300 GHz, etc.). Such radio waves may be used to determine the distance to and/or velocity of one or more objects in the surrounding environment of the vehicle 200. For example, one or more sensor systems 202, 204, 206, 208, 210, 212, 214, and/or 218 could include one or more radars. In some examples, one or more radars can be located near the rear of the vehicle 200 (e.g., sensor systems 208, 210, etc.), to actively scan the environment near the back of the vehicle 200 for the presence of radio-reflective objects. Similarly, one or more radars can be located near the front of the vehicle 200 (e.g., sensor systems 212, 214, etc.) to actively scan the environment near the front of the vehicle 200. A radar can be situated, for example, in a location suitable to illuminate a region including a forward-moving path of the vehicle 200 without occlusion by other features of the vehicle 200. For example, a radar can be embedded in and/or mounted in or near the front bumper, front headlights, cowl, and/or hood, etc. Furthermore, one or more additional radars can be located to actively scan the side and/or rear of the vehicle 200 for the presence of radio-reflective objects, such as by including such devices in or near the rear bumper, side panels, rocker panels, and/or undercarriage, etc.

The vehicle 200 can include one or more cameras. For example, the one or more sensor systems 202, 204, 206, 208, 210, 212, 214, and/or 218 could include one or more cameras. The camera can be a photosensitive instrument, such as a still camera, a video camera, a thermal imaging camera, a stereo camera, a night vision camera, etc., that is configured to capture a plurality of images of the surrounding environment of the vehicle 200. To this end, the camera can be configured to detect visible light, and can additionally or alternatively be configured to detect light from other portions of the spectrum, such as infrared or ultraviolet light. The camera can be a two-dimensional detector, and can optionally have a three-dimensional spatial range of sensitivity. In some embodiments, the camera can include, for example, a range detector configured to generate a two-dimensional image indicating distance from the camera to a number of points in the surrounding environment. To this end, the camera may use one or more range detecting techniques. For example, the camera can provide range information by using a structured light technique in which the vehicle 200 illuminates an object in the surrounding environment with a predetermined light pattern, such as a grid or checkerboard pattern and uses the camera to detect a reflection of the predetermined light pattern from environmental surroundings. Based on distortions in the reflected light pattern, the vehicle 200 can determine the distance to the points on the object. The predetermined light pattern may comprise infrared light, or radiation at other suitable wavelengths for such measurements. In some examples, the camera can be mounted inside a front windshield of the vehicle 200. Specifically, the camera can be situated to capture images from a forward-looking view with respect to the orientation of the vehicle 200. Other mounting locations and viewing angles of the camera can also be used, either inside or outside the vehicle 200. Further, the camera can have associated optics operable to provide an adjustable field of view. Still further, the camera can be mounted to vehicle 200 with a movable mount to vary a pointing angle of the camera, such as via a pan/tilt mechanism.

The vehicle 200 may also include one or more acoustic sensors (e.g., one or more of the sensor systems 202, 204, 206, 208, 210, 212, 214, 216, 218 may include one or more acoustic sensors, etc.) used to sense a surrounding environment of vehicle 200. Acoustic sensors may include microphones (e.g., piezoelectric microphones, condenser microphones, ribbon microphones, microelectromechanical systems (MEMS) microphones, etc.) used to sense acoustic waves (i.e., pressure differentials) in a fluid (e.g., air, etc.) of the environment surrounding the vehicle 200. Such acoustic sensors may be used to identify sounds in the surrounding environment (e.g., sirens, human speech, animal sounds, alarms, etc.) upon which control strategy for vehicle 200 may be based. For example, if the acoustic sensor detects a siren (e.g., an ambulatory siren, a fire engine siren, etc.), vehicle 200 may slow down and/or navigate to the edge of a roadway.

Although not shown in FIGS. 2A-2E, the vehicle 200 can include a wireless communication system (e.g., similar to the wireless communication system 146 of FIG. 1 and/or in addition to the wireless communication system 146 of FIG. 1, etc.). The wireless communication system may include wireless transmitters and receivers that could be configured to communicate with devices external or internal to the vehicle 200. Specifically, the wireless communication system could include transceivers configured to communicate with other vehicles and/or computing devices, for instance, in a vehicular communication system or a roadway station. Examples of such vehicular communication systems include DSRC, radio frequency identification (RFID), and other proposed communication standards directed towards intelligent transport systems.

The vehicle 200 may include one or more other components in addition to or instead of those shown. The additional components may include electrical or mechanical functionality.

A control system of the vehicle 200 may be configured to control the vehicle 200 in accordance with a control strategy from among multiple possible control strategies. The control system may be configured to receive information from sensors coupled to the vehicle 200 (on or off the vehicle 200), modify the control strategy (and an associated driving behavior) based on the information, and control the vehicle 200 in accordance with the modified control strategy. The control system further may be configured to monitor the information received from the sensors, and continuously evaluate driving conditions; and also may be configured to modify the control strategy and driving behavior based on changes in the driving conditions. For example, a route taken by a vehicle from one destination to another may be modified based on driving conditions. Additionally or alternatively, the velocity, acceleration, turn angle, follow distance (i.e., distance to a vehicle ahead of the present vehicle), lane selection, etc. could all be modified in response to changes in the driving conditions.

As described above, in some embodiments, the vehicle 200 may take the form of a van, but alternate forms are also possible and are contemplated herein. As such, FIGS. 2F-2I illustrate embodiments where a vehicle 250 takes the form of a semi-truck. For example, FIG. 2F illustrates a front-view of the vehicle 250 and FIG. 2G illustrates an isometric view of the vehicle 250. In embodiments where the vehicle 250 is a semi-truck, the vehicle 250 may include a tractor portion 260 and a trailer portion 270 (illustrated in FIG. 2G). FIGS. 2H and 2I provide a side view and a top view, respectively, of the tractor portion 260. Similar to the vehicle 200 illustrated above, the vehicle 250 illustrated in FIGS. 2F-2I may also include a variety of sensor systems (e.g., similar to the sensor systems 202, 206, 208, 210, 212, 214 shown and described with reference to FIGS. 2A-2E). In some embodiments, whereas the vehicle 200 of FIGS. 2A-2E may only include a single copy of some sensor systems (e.g., the sensor system 204), the vehicle 250 illustrated in FIGS. 2F-2I may include multiple copies of that sensor system (e.g., the sensor systems 204A and 204B, as illustrated).

While drawings and description throughout may reference a given form of vehicle (e.g., the semi-truck vehicle 250 or the van vehicle 200), it is understood that embodiments described herein can be equally applied in a variety of vehicle contexts (e.g., with modifications employed to account for a form factor of vehicle). For example, sensors and/or other components described or illustrated as being part of the van vehicle 200 could also be used (e.g., for navigation and/or obstacle detection and avoidance) in the semi-truck vehicle 250

FIG. 2J illustrates various sensor fields of view (e.g., associated with the vehicle 250 described above). As described above, vehicle 250 may contain a plurality of sensors/sensor units. The locations of the various sensors may correspond to the locations of the sensors disclosed in FIGS. 2F-2I, for example. However, in some instances, the sensors may have other locations. Sensors location reference numbers are omitted from FIG. 2J for simplicity of the drawing. For each sensor unit of vehicle 250, FIG. 2J illustrates a representative field of view (e.g., fields of view labeled as 252A, 252B, 252C, 252D, 254A, 254B, 256, 258A, 258B, and 258C). The field of view of a sensor may include an angular region (e.g., an azimuthal angular region and/or an elevational angular region) over which the sensor may detect objects.

FIG. 2K illustrates beam steering for a sensor of a vehicle (e.g., the vehicle 250 shown and described with reference to FIGS. 2F-2J), according to example embodiments. In various embodiments, a sensor unit of vehicle 250 may be a radar, a lidar, a sonar, etc. Further, in some embodiments, during the operation of the sensor, the sensor may be scanned within the field of view of the sensor. Various different scanning angles for an example sensor are shown as regions 272, which each indicate the angular region over which the sensor is operating. The sensor may periodically or iteratively change the region over which it is operating. In some embodiments, multiple sensors may be used by vehicle 250 to measure regions 272. In addition, other regions may be included in other examples. For instance, one or more sensors may measure aspects of the trailer 270 of vehicle 250 and/or a region directly in front of vehicle 250.

At some angles, region of operation 275 of the sensor may include rear wheels 276A, 276B of trailer 270. Thus, the sensor may measure rear wheel 276A and/or rear wheel 276B during operation. For example, rear wheels 276A, 276B may reflect lidar signals or radar signals transmitted by the sensor. The sensor may receive the reflected signals from rear wheels 276A, 276. Therefore, the data collected by the sensor may include data from the reflections off the wheel.

In some instances, such as when the sensor is a radar, the reflections from rear wheels 276A, 276B may appear as noise in the received radar signals. Consequently, the radar may operate with an enhanced signal to noise ratio in instances where rear wheels 276A, 276B direct radar signals away from the sensor.

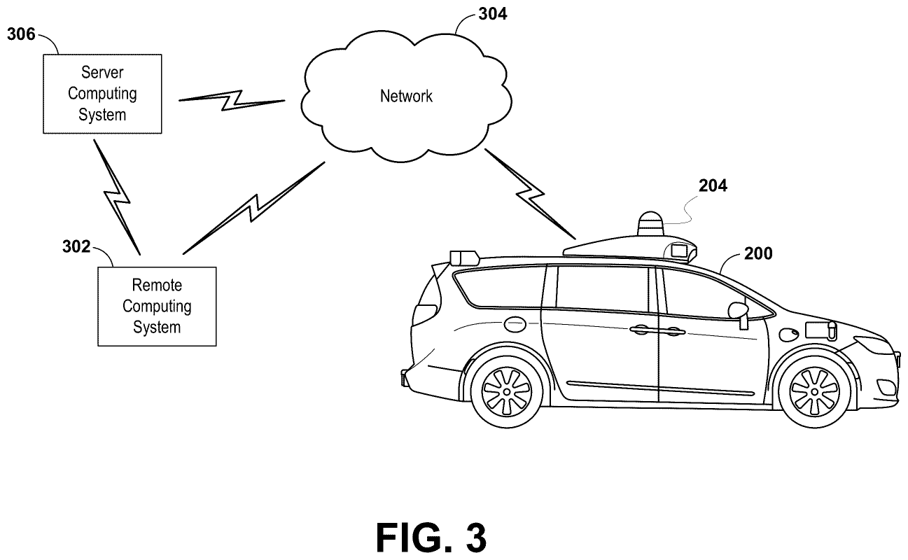

FIG. 3 is a conceptual illustration of wireless communication between various computing systems related to an autonomous or semi-autonomous vehicle, according to example embodiments. In particular, wireless communication may occur between remote computing system 302 and vehicle 200 via network 304. Wireless communication may also occur between server computing system 306 and remote computing system 302, and between server computing system 306 and vehicle 200.

Vehicle 200 can correspond to various types of vehicles capable of transporting passengers or objects between locations, and may take the form of any one or more of the vehicles discussed above. In some instances, vehicle 200 may operate in an autonomous or semi-autonomous mode that enables a control system to safely navigate vehicle 200 between destinations using sensor measurements. When operating in an autonomous or semi-autonomous mode, vehicle 200 may navigate with or without passengers. As a result, vehicle 200 may pick up and drop off passengers between desired destinations.

Remote computing system 302 may represent any type of device related to remote assistance techniques, including but not limited to those described herein. Within examples, remote computing system 302 may represent any type of device configured to (i) receive information related to vehicle 200, (ii) provide an interface through which a human operator can in turn perceive the information and input a response related to the information, and (iii) transmit the response to vehicle 200 or to other devices. Remote computing system 302 may take various forms, such as a workstation, a desktop computer, a laptop, a tablet, a mobile phone (e.g., a smart phone, etc.), and/or a server. In some examples, remote computing system 302 may include multiple computing devices operating together in a network configuration.

Remote computing system 302 may include one or more subsystems and components similar or identical to the subsystems and components of vehicle 200. At a minimum, remote computing system 302 may include a processor configured for performing various operations described herein. In some embodiments, remote computing system 302 may also include a user interface that includes input/output devices, such as a touchscreen and a speaker. Other examples are possible as well.

Network 304 represents infrastructure that enables wireless communication between remote computing system 302 and vehicle 200. Network 304 also enables wireless communication between server computing system 306 and remote computing system 302, and between server computing system 306 and vehicle 200.

The position of remote computing system 302 can vary within examples. For instance, remote computing system 302 may have a remote position from vehicle 200 that has a wireless communication via network 304. In another example, remote computing system 302 may correspond to a computing device within vehicle 200 that is separate from vehicle 200, but with which a human operator can interact while a passenger or driver of vehicle 200. In some examples, remote computing system 302 may be a computing device with a touchscreen operable by the passenger of vehicle 200.

In some embodiments, operations described herein that are performed by remote computing system 302 may be additionally or alternatively performed by vehicle 200 (i.e., by any system(s) or subsystem(s) of vehicle 200). In other words, vehicle 200 may be configured to provide a remote assistance mechanism with which a driver or passenger of the vehicle can interact.

Server computing system 306 may be configured to wirelessly communicate with remote computing system 302 and vehicle 200 via network 304 (or perhaps directly with remote computing system 302 and/or vehicle 200). Server computing system 306 may represent any computing device configured to receive, store, determine, and/or send information relating to vehicle 200 and the remote assistance thereof. As such, server computing system 306 may be configured to perform any operation(s), or portions of such operation(s), that is/are described herein as performed by remote computing system 302 and/or vehicle 200. Some embodiments of wireless communication related to remote assistance may utilize server computing system 306, while others may not.

Server computing system 306 may include one or more subsystems and components similar or identical to the subsystems and components of remote computing system 302 and/or vehicle 200, such as a processor configured for performing various operations described herein, and a wireless communication interface for receiving information from, and providing information to, remote computing system 302 and vehicle 200.

The various systems described above may perform various operations. These operations and related features will now be described.

In line with the discussion above, a computing system (e.g., remote computing system 302, server computing system 306, a computing system local to vehicle 200, etc.) may operate to use a camera to capture images of the surrounding environment of an autonomous or semi-autonomous vehicle. In general, at least one computing system will be able to analyze the images and possibly control the autonomous or semi-autonomous vehicle.

In some embodiments, to facilitate autonomous or semi-autonomous operation, a vehicle (e.g., vehicle 200, etc.) may receive data representing objects in an environment surrounding the vehicle (also referred to herein as “environment data”) in a variety of ways. A sensor system on the vehicle may provide the environment data representing objects of the surrounding environment. For example, the vehicle may have various sensors, including a camera, a radar, a lidar, a microphone, a radio unit, and other sensors. Each of these sensors may communicate environment data to a processor in the vehicle about information each respective sensor receives.

In one example, a camera may be configured to capture still images and/or video. In some embodiments, the vehicle may have more than one camera positioned in different orientations. Also, in some embodiments, the camera may be able to move to capture images and/or video in different directions. The camera may be configured to store captured images and video to a memory for later processing by a processing system of the vehicle. The captured images and/or video may be the environment data. Further, the camera may include an image sensor as described herein.

In another example, a radar may be configured to transmit an electromagnetic signal that will be reflected by various objects near the vehicle, and then capture electromagnetic signals that reflect off the objects. The captured reflected electromagnetic signals may enable the radar (or processing system) to make various determinations about objects that reflected the electromagnetic signal. For example, the distances to and positions of various reflecting objects may be determined. In some embodiments, the vehicle may have more than one radar in different orientations. The radar may be configured to store captured information to a memory for later processing by a processing system of the vehicle. The information captured by the radar may be environment data.

In another example, a lidar may be configured to transmit an electromagnetic signal (e.g., infrared light, such as that from a gas or diode laser, or other possible light source) that will be reflected by target objects near the vehicle. The lidar may be able to capture the reflected electromagnetic (e.g., infrared light, etc.) signals. The captured reflected electromagnetic signals may enable the range-finding system (or processing system) to determine a range to various objects. The lidar may also be able to determine a velocity or speed of target objects and store it as environment data.

Additionally, in an example, a microphone may be configured to capture audio of the environment surrounding the vehicle. Sounds captured by the microphone may include emergency vehicle sirens and the sounds of other vehicles. For example, the microphone may capture the sound of the siren of an ambulance, fire engine, or police vehicle. A processing system may be able to identify that the captured audio signal is indicative of an emergency vehicle. In another example, the microphone may capture the sound of an exhaust of another vehicle, such as that from a motorcycle. A processing system may be able to identify that the captured audio signal is indicative of a motorcycle. The data captured by the microphone may form a portion of the environment data.

In yet another example, the radio unit may be configured to transmit an electromagnetic signal that may take the form of a Bluetooth signal, 802.11 signal, and/or other radio technology signal. The first electromagnetic radiation signal may be transmitted via one or more antennas located in a radio unit. Further, the first electromagnetic radiation signal may be transmitted with one of many different radio-signaling modes. However, in some embodiments it is desirable to transmit the first electromagnetic radiation signal with a signaling mode that requests a response from devices located near the autonomous or semi-autonomous vehicle. The processing system may be able to detect nearby devices based on the responses communicated back to the radio unit and use this communicated information as a portion of the environment data.

In some embodiments, the processing system may be able to combine information from the various sensors in order to make further determinations of the surrounding environment of the vehicle. For example, the processing system may combine data from both radar information and a captured image to determine if another vehicle or pedestrian is in front of the autonomous or semi-autonomous vehicle. In other embodiments, other combinations of sensor data may be used by the processing system to make determinations about the surrounding environment.

While operating in an autonomous mode (or semi-autonomous mode), the vehicle may control its operation with little-to-no human input. For example, a human-operator may enter an address into the vehicle and the vehicle may then be able to drive, without further input from the human (e.g., the human does not have to steer or touch the brake/gas pedals, etc.), to the specified destination. Further, while the vehicle is operating autonomously or semi-autonomously, the sensor system may be receiving environment data. The processing system of the vehicle may alter the control of the vehicle based on environment data received from the various sensors. In some examples, the vehicle may alter a velocity of the vehicle in response to environment data from the various sensors. The vehicle may change velocity in order to avoid obstacles, obey traffic laws, etc. When a processing system in the vehicle identifies objects near the vehicle, the vehicle may be able to change velocity, or alter the movement in another way.

When the vehicle detects an object but is not highly confident in the detection of the object, the vehicle can request a human operator (or a more powerful computer) to perform one or more remote assistance tasks, such as (i) confirm whether the object is in fact present in the surrounding environment (e.g., if there is actually a stop sign or if there is actually no stop sign present, etc.), (ii) confirm whether the vehicle's identification of the object is correct, (iii) correct the identification if the identification was incorrect, and/or (iv) provide a supplemental instruction (or modify a present instruction) for the autonomous or semi-autonomous vehicle. Remote assistance tasks may also include the human operator providing an instruction to control operation of the vehicle (e.g., instruct the vehicle to stop at a stop sign if the human operator determines that the object is a stop sign, etc.), although in some scenarios, the vehicle itself may control its own operation based on the human operator's feedback related to the identification of the object.

To facilitate this, the vehicle may analyze the environment data representing objects of the surrounding environment to determine at least one object having a detection confidence below a threshold. A processor in the vehicle may be configured to detect various objects of the surrounding environment based on environment data from various sensors. For example, in one embodiment, the processor may be configured to detect objects that may be important for the vehicle to recognize. Such objects may include pedestrians, bicyclists, street signs, other vehicles, indicator signals on other vehicles, and other various objects detected in the captured environment data.

The detection confidence may be indicative of a likelihood that the determined object is correctly identified in the surrounding environment, or is present in the surrounding environment. For example, the processor may perform object detection of objects within image data in the received environment data, and determine that at least one object has the detection confidence below the threshold based on being unable to identify the object with a detection confidence above the threshold. If a result of an object detection or object recognition of the object is inconclusive, then the detection confidence may be low or below the set threshold.

The vehicle may detect objects of the surrounding environment in various ways depending on the source of the environment data. In some embodiments, the environment data may come from a camera and be image or video data. In other embodiments, the environment data may come from a lidar. The vehicle may analyze the captured image or video data to identify objects in the image or video data. The methods and apparatuses may be configured to monitor image and/or video data for the presence of objects of the surrounding environment. In other embodiments, the environment data may be radar, audio, or other data. The vehicle may be configured to identify objects of the surrounding environment based on the radar, audio, or other data.

In some embodiments, the techniques the vehicle uses to detect objects may be based on a set of known data. For example, data related to environmental objects may be stored to a memory located in the vehicle. The vehicle may compare received data to the stored data to determine objects. In other embodiments, the vehicle may be configured to determine objects based on the context of the data. For example, street signs related to construction may generally have an orange color. Accordingly, the vehicle may be configured to detect objects that are orange, and located near the side of roadways as construction-related street signs. Additionally, when the processing system of the vehicle detects objects in the captured data, it also may calculate a confidence for each object.

Further, the vehicle may also have a confidence threshold. The confidence threshold may vary depending on the type of object being detected. For example, the confidence threshold may be lower for an object that may require a quick responsive action from the vehicle, such as brake lights on another vehicle. However, in other embodiments, the confidence threshold may be the same for all detected objects. When the confidence associated with a detected object is greater than the confidence threshold, the vehicle may assume the object was correctly recognized and responsively adjust the control of the vehicle based on that assumption.

When the confidence associated with a detected object is less than the confidence threshold, the actions that the vehicle takes may vary. In some embodiments, the vehicle may react as if the detected object is present despite the low confidence level. In other embodiments, the vehicle may react as if the detected object is not present.

When the vehicle detects an object of the surrounding environment, it may also calculate a confidence associated with the specific detected object. The confidence may be calculated in various ways depending on the embodiment. In one example, when detecting objects of the surrounding environment, the vehicle may compare environment data to predetermined data relating to known objects. The closer the match between the environment data and the predetermined data, the higher the confidence. In other embodiments, the vehicle may use mathematical analysis of the environment data to determine the confidence associated with the objects.

In response to determining that an object has a detection confidence that is below the threshold, the vehicle may transmit, to the remote computing system, a request for remote assistance with the identification of the object. As discussed above, the remote computing system may take various forms. For example, the remote computing system may be a computing device within the vehicle that is separate from the vehicle, but with which a human operator can interact while a passenger or driver of the vehicle, such as a touchscreen interface for displaying remote assistance information. Additionally or alternatively, as another example, the remote computing system may be a remote computer terminal or other device that is located at a location that is not near the vehicle.

The request for remote assistance may include the environment data that includes the object, such as image data, audio data, etc. The vehicle may transmit the environment data to the remote computing system over a network (e.g., network 304, etc.), and in some embodiments, via a server (e.g., server computing system 306, etc.). The human operator of the remote computing system may in turn use the environment data as a basis for responding to the request.

In some embodiments, when the object is detected as having a confidence below the confidence threshold, the object may be given a preliminary identification, and the vehicle may be configured to adjust the operation of the vehicle in response to the preliminary identification. Such an adjustment of operation may take the form of stopping the vehicle, switching the vehicle to a human-controlled mode, changing a velocity of the vehicle (e.g., a speed and/or direction, etc.), among other possible adjustments.

In other embodiments, even if the vehicle detects an object having a confidence that meets or exceeds the threshold, the vehicle may operate in accordance with the detected object (e.g., come to a stop if the object is identified with high confidence as a stop sign, etc.), but may be configured to request remote assistance at the same time as (or at a later time from) when the vehicle operates in accordance with the detected object.

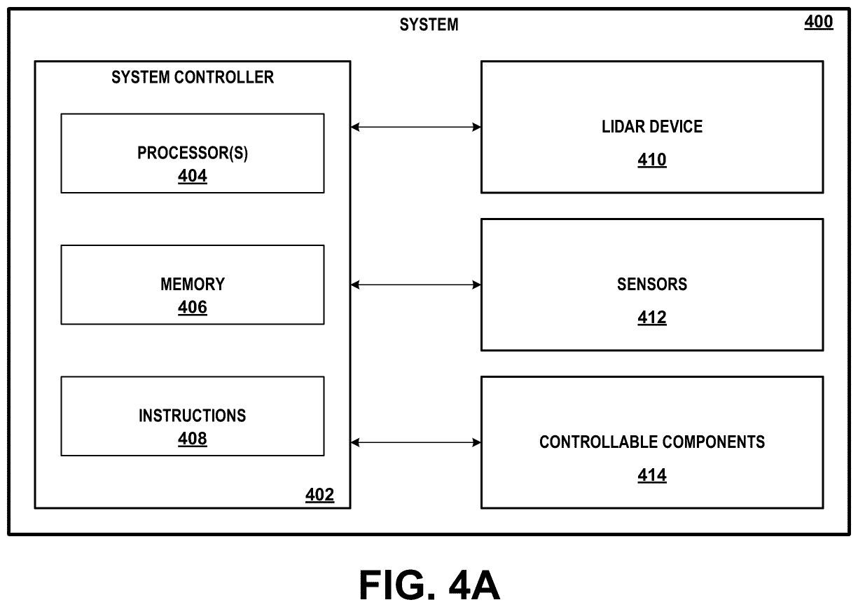

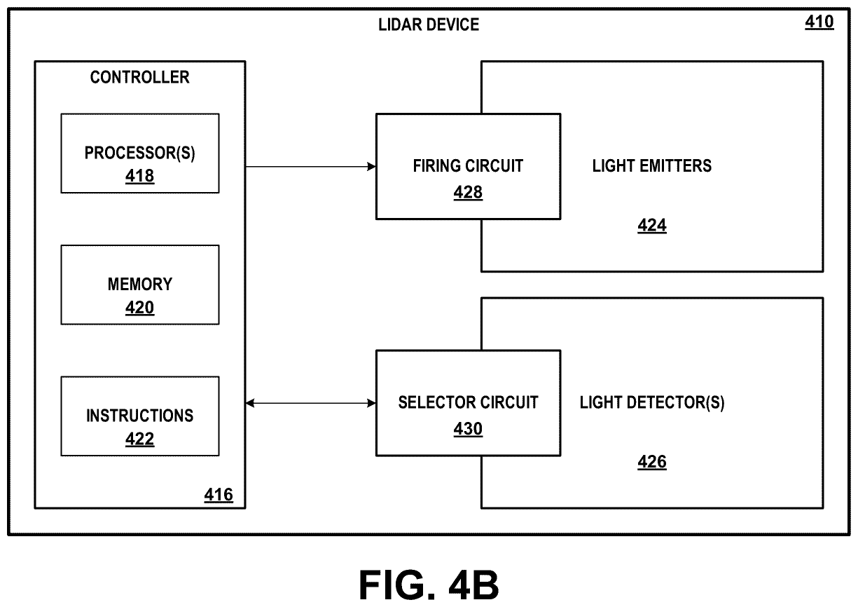

FIG. 4A is a block diagram of a system, according to example embodiments. In particular, FIG. 4A shows a system 400 that includes a system controller 402, a lidar device 410, a plurality of sensors 412, and a plurality of controllable components 414. System controller 402 includes processor(s) 404, a memory 406, and instructions 408 stored on the memory 406 and executable by the processor(s) 404 to perform functions.

The processor(s) 404 can include one or more processors, such as one or more general-purpose microprocessors (e.g., having a single core or multiple cores, etc.) and/or one or more special purpose microprocessors. The one or more processors may include, for instance, one or more central processing units (CPUs), one or more microcontrollers, one or more graphical processing units (GPUs), one or more tensor processing units (TPUs), one or more ASICs, and/or one or more field-programmable gate arrays (FPGAs). Other types of processors, computers, or devices configured to carry out software instructions are also contemplated herein.

The memory 406 may include a computer-readable medium, such as a non-transitory, computer-readable medium, which may include without limitation, read-only memory (ROM), programmable read-only memory (PROM), erasable programmable read-only memory (EPROM), electrically erasable programmable read-only memory (EEPROM), non-volatile random-access memory (e.g., flash memory, etc.), a solid state drive (SSD), a hard disk drive (HDD), a Compact Disc (CD), a Digital Video Disk (DVD), a digital tape, read/write (R/W) CDs, R/W DVDs, etc.

The lidar device 410, described further below, includes a plurality of light emitters configured to emit light (e.g., in light pulses, etc.) and one or more light detectors configured to detect light (e.g., reflected portions of the light pulses, etc.). The lidar device 410 may generate three-dimensional (3D) point cloud data from outputs of the light detector(s), and provide the 3D point cloud data to the system controller 402. The system controller 402, in turn, may perform operations on the 3D point cloud data to determine the characteristics of a surrounding environment (e.g., relative positions of objects within a surrounding environment, edge detection, object detection, proximity sensing, etc.).

Similarly, the system controller 402 may use outputs from the plurality of sensors 412 to determine the characteristics of the system 400 and/or characteristics of the surrounding environment. For example, the sensors 412 may include one or more of a GPS, an IMU, an image capture device (e.g., a camera, etc.), a light sensor, a heat sensor, and other sensors indicative of parameters relevant to the system 400 and/or the surrounding environment. The lidar device 410 is depicted as separate from the sensors 412 for purposes of example, and may be considered as part of or as the sensors 412 in some examples.

Based on characteristics of the system 400 and/or the surrounding environment determined by the system controller 402 based on the outputs from the lidar device 410 and the sensors 412, the system controller 402 may control the controllable components 414 to perform one or more actions. For example, the system 400 may correspond to a vehicle, in which case the controllable components 414 may include a braking system, a turning system, and/or an accelerating system of the vehicle, and the system controller 402 may change aspects of these controllable components based on characteristics determined from the lidar device 410 and/or sensors 412 (e.g., when the system controller 402 controls the vehicle in an autonomous or semi-autonomous mode, etc.). Within examples, the lidar device 410 and the sensors 412 are also controllable by the system controller 402.

FIG. 4B is a block diagram of a lidar device, according to an example embodiment. In particular, FIG. 4B shows a lidar device 410, having a controller 416 configured to control a plurality of light emitters 424 and one or more light detector(s), e.g., a plurality of light detectors 426, etc. The lidar device 410 further includes a firing circuit 428 configured to select and provide power to respective light emitters of the plurality of light emitters 424 and may include a selector circuit 430 configured to select respective light detectors of the plurality of light detectors 426. The controller 416 includes processor(s) 418, a memory 420, and instructions 422 stored on the memory 420.

Similar to processor(s) 404, the processor(s) 418 can include one or more processors, such as one or more general-purpose microprocessors and/or one or more special purpose microprocessors. The one or more processors may include, for instance, one or more CPUs, one or more microcontrollers, one or more GPUs, one or more TPUs, one or more ASICs, and/or one or more FPGAs. Other types of processors, computers, or devices configured to carry out software instructions are also contemplated herein.

Similar to memory 406, the memory 420 may include a computer-readable medium, such as a non-transitory, computer-readable medium, such as, but not limited to, ROM, PROM, EPROM, EEPROM, non-volatile random-access memory (e.g., flash memory, etc.), a SSD, a HDD, a CD, a DVD, a digital tape, R/W CDs, R/W DVDs, etc.

The instructions 422 are stored on memory 420 and executable by the processor(s) 418 to perform functions related to controlling the firing circuit 428 and the selector circuit 430, for generating 3D point cloud data, and for processing the 3D point cloud data (or perhaps facilitating processing the 3D point cloud data by another computing device, such as the system controller 402).

The controller 416 can determine 3D point cloud data by using the light emitters 424 to emit pulses of light. A time of emission is established for each light emitter and a relative location at the time of emission is also tracked. Aspects of a surrounding environment of the lidar device 410, such as various objects, reflect the pulses of light. For example, when the lidar device 410 is in a surrounding environment that includes a road, such objects may include vehicles, signs, pedestrians, road surfaces, construction cones, etc. Some objects may be more reflective than others, such that an intensity of reflected light may indicate a type of object that reflects the light pulses. Further, surfaces of objects may be at different positions relative to the lidar device 410, and thus take more or less time to reflect portions of light pulses back to the lidar device 410. Accordingly, the controller 416 may track a detection time at which a reflected light pulse is detected by a light detector and a relative position of the light detector at the detection time. By measuring time differences between emission times and detection times, the controller 416 can determine how far the light pulses travel prior to being received, and thus a relative distance of a corresponding object. By tracking relative positions at the emission times and detection times the controller 416 can determine an orientation of the light pulse and reflected light pulse relative to the lidar device 410, and thus a relative orientation of the object. By tracking intensities of received light pulses, the controller 416 can determine how reflective the object is. The 3D point cloud data determined based on this information may thus indicate relative positions of detected reflected light pulses (e.g., within a coordinate system, such as a Cartesian coordinate system, etc.) and intensities of each reflected light pulse.

The firing circuit 428 is used for selecting light emitters for emitting light pulses. The selector circuit 430 similarly is used for sampling outputs from light detectors.

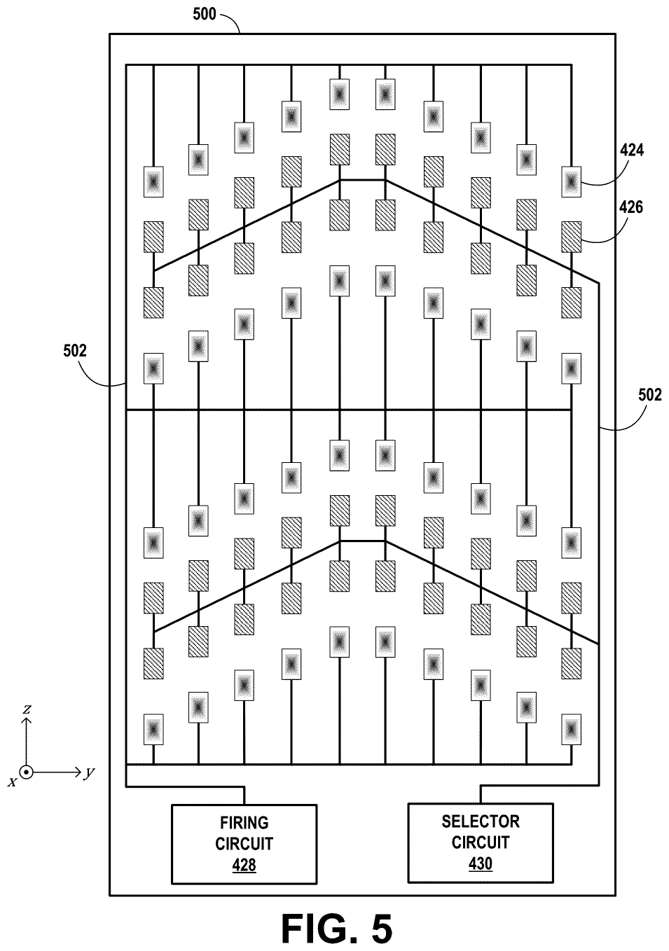

FIG. 5 is an illustration of an array of channels within a lidar device, according to example embodiments. In some embodiments, FIG. 5 may represent the physical arrangement of the light emitters 424 and the light detectors 426 within the lidar device 410 shown and described with reference to FIG. 4B. Such light emitters 424 and light detectors 426 may be positioned on (e.g., mounted to or fabricated on) a substrate 500, in some embodiments. Each channel may include a single light emitter 424 and a single corresponding light detector 426. For example, as illustrated in FIG. 5, a light detector 426 may be positioned immediately adjacent to (e.g., above or below along the z-direction, as illustrated) its corresponding light emitter 424 on the substrate 500. It is understood, however, that other embodiments are also possible and contemplated herein. For example, multiple light detectors may correspond to a single light emitter, multiple light emitters may correspond to a single light detector, and/or light detectors may not be positioned adjacent to their corresponding light emitters.

Further, as illustrated in FIG. 5, the light emitters 424 and light detectors 426 may be connected (e.g., electrically) to the firing circuit 428 and the selector circuit 430, respectively (e.g., similar to FIG. 4B). Such connections may occur using connective traces 502, for example. It is understood, however, that the techniques described herein remain broadly applicable and that the arrangement of FIG. 5, including the incorporation of the firing circuit 428 and the selector circuit 430, is provided solely as an example.

The light emitters 424 in the array may include light sources such as laser diodes. In some embodiments, the light emitters 424 may include pulsed light sources. For example, the light sources may include one or more pulsed lasers (e.g., a Q-switched laser). In alternate embodiments, a continuous wave (CW) light source may be used. In some embodiments, the light emitters 424 may include a fiber laser coupled to an optical amplifier. In particular, the fiber laser may be a laser in which an active gain medium (i.e., source of optical gain within the laser) is in an optical fiber. Moreover, the fiber laser could be arranged in various ways within lidar device 410 (e.g., partially disposed on the substrate 500 or entirely disposed on the substrate 500). In still other embodiments, however, one or more light emitters 424 in the array may additionally or alternatively include light emitting diodes (LEDs), vertical cavity surface emitting lasers (VCSELs), organic light emitting diodes (OLEDs), polymer light emitting diodes (PLEDs), light emitting polymers (LEPs), liquid crystal displays (LCDs), microelectromechanical systems (MEMS), and/or any other device configured to selectively transmit, reflect, and/or emit light to provide emitted light beams and/or pulses. The light emitters 424 may be configured to emit light signals toward objects in a surrounding environment that, when reflected by such objects, can be detected by the light detectors 426 to determine a distance between the lidar device 410 and the respective object.

The wavelength range emitted by the light emitters 424 could, for example, be in the ultraviolet, visible, and/or infrared portions of the electromagnetic spectrum. In some examples, the wavelength range can be a narrow wavelength range, such as is provided by lasers. In some embodiments, the wavelength range includes wavelengths that are approximately 905 nm. It is noted that this wavelength is provided only as an example and is not meant to be limiting.

Though not illustrated in FIG. 5, it is understood that light signals (e.g., light pulses) emitted by the light emitters 424 in the array may be transmitted into the surrounding environment via one or more lenses, mirrors, chromatic filters, polarizers, waveguides, apertures, etc. For example, in some embodiments, light signals from the light emitters 424 may be redirected, focused, collimated, filtered, and/or otherwise adjusted prior to being transmitted to the surrounding environment. In some embodiments, the light emitters 424 may transmit light signals into the surrounding environment using shared optics (e.g., a single lens shared among all of the light emitters 424 or a group of the light emitters 424) and/or using optics that only correspond to a single light emitter 424 (e.g., a polarizer or chromatic filter only used by that light emitter 424).

In some embodiments, for example, each of the light emitters 424 may transmit light signals to different regions of the surrounding environment to observe a field of view in the surrounding environment. The location within the surrounding environment at which a given light emitter 424 may be transmitting a light signal may depend on the position of the light emitter 424 (e.g., the (y, z) position of the light emitter 424 on the substrate 500); the angular orientation of the light emitter 424 relative to the surface of the substrate 500, if any; and/or the positions/orientations of the optics (e.g., mirrors, lenses, etc.) by which the light emitter 424 is providing the light signal to the surrounding environment. In just one example, the light emitters 424 on the substrate 500 may emit light signals into the surrounding environment across a range of azimuthal angles and/or elevation angles (e.g., to interrogate a corresponding range of angles within the surrounding environment) based on the positions of the light emitters 424 on the substrate 500 relative to a shared telecentric lens assembly used by each of the light emitters 424 to provide light to a surrounding environment. Because of the shape of the shared telecentric lens assembly, the light signals may be spread across a range of azimuthal angles and/or elevation angles.

The light detectors 426 may include various types of detectors (e.g., single-photon detectors). For example, the light detectors 426 may include SPADs and/or SiPMs. SPADs may employ avalanche breakdown within a reverse biased p-n junction (i.e., diode) to increase an output current for a given incident illumination on the SPAD. Further, SPADs may be able to generate multiple electron-hole pairs for a single incident photon. Additionally or alternatively, the light detectors 426 may include linear-mode APDs. In some embodiments, the light detectors 426 may be biased above an avalanche breakdown voltage. Such a biasing condition may create a positive feedback loop having a loop gain that is greater than one. In addition, SPADs biased above the threshold avalanche breakdown voltage may be single-photon sensitive. In other examples, the light detectors 426 may include photoresistors, charge-coupled devices (CCDs), photovoltaic cells, and/or any other type of light detector.

In some implementations, the array of light detectors 426 may include more than one type of light detector across the array. For example, the array of light detectors 426 can be configured to detect multiple predefined wavelengths of light (e.g., in embodiments where the light emitters 424 emit different wavelengths of light across the array of light emitters 424). To that end, for example, the array of light detectors 426 may include some SPADs that are sensitive to one range of wavelengths and other SPADs that are sensitive to a different range of wavelengths. In some embodiments, the light detectors 426 may be sensitive to wavelengths between 400 nm and 1.6 μm (visible and/or infrared wavelengths). Further, the light detectors 426 may have various sizes and shapes. For example, the light detectors 426 may include SPADs that have package sizes that are 1%, 0.1%, or 0.01% of the total area of the substrate 500. Still further, in some embodiments, one or more of the light detectors 426 may include detector-specific optics. For example, each of the light detectors 426 may include a micro-lens positioned over the light detector 426 to enhance the amount of received light that is transmitted to a detection surface of the light detector 426. Additionally or alternatively, one or more of the light detectors 426 may include one or more optical filters (e.g., neutral-density filter(s), polarization filter(s), and/or chromatic filter(s)).

As described above, each of the light detectors 426 may correspond to a light emitter 424. In some embodiments, the light detectors 426 may receive light from the surrounding scene via one or more optics (e.g., chromatic filters, polarizers, lenses, mirrors, waveguides, etc.). Such optics may be specific to one of the light detectors 426 and/or shared by groups of light detectors 426 (e.g., all the light detectors on the substrate 500). Even further, in some embodiments, one or more of the receive optics may be part of a transmit path for one or more of the light emitters 424, in addition to being a part of a receive path for one or more of the light detectors 426. For example, a mirror may reflect light from one or more of the light emitters 424 into a surrounding environment and may also direct light received from the surrounding environment to one or more of the light detectors 426.

As described above, the light emitters 424 may be configured to transmit light signals to a surrounding environment across a range of azimuthal and/or elevation angles (i.e., yaw angles and/or pitch angles). Similarly, based on the positions of the light detectors 426 in the lidar device 410, the light detectors 426 may be arranged to receive light signals reflected from objects in the environment surrounding the lidar device 410 across a corresponding range of azimuthal and/or elevation angles (i.e., yaw angles and/or pitch angles).

The array of light emitters 424 may be powered by and/or controlled by the firing circuit 428. Likewise, the light detectors 426 may be powered by, controlled by, and/or provide detection signals to the selector circuit 430. As illustrated in FIG. 5, the firing circuit 428 may be connected to one or more of the light emitters 424 by conductive traces 502 defined in the substrate 500 and the selector circuit 430 may be connected to one or more of the light detectors 426 by conductive traces 502 defined in the substrate 500. FIG. 5 illustrates a first conductive trace 502 connecting the firing circuit 428 to the light emitters 424 and a second conductive trace 502 connecting the selector circuit 430 to the light detectors 426. It is understood that this is provided solely as an example. In other embodiments, the firing circuit 428 may be connected individually to each of the light emitters 424 by separate conductive traces 502. Likewise, the selector circuit 430 may be connected individually to each of the light detectors 426 by separate conductive traces 502. Alternatively, the firing circuit 428 may be connected to banks of light emitters 424 by a single conductive trace 502 and/or the selector circuit 430 may be connected to banks of light detectors 426 by a single conductive trace 502. For example, groups of five light emitters 424 may be connected to the firing circuit 428 by a single conductive trace 502. In this way, banks of five light emitters 424 could be fired simultaneously by the firing circuit 428. Other numbers of light emitters 424 or light detectors 426 within a group are also possible.

In some embodiments, the firing circuit 428 may include one or more capacitors. Such capacitors may be charged by one or more power supplies. Then, to cause the light emitters 424 to emit light signals (i.e., to “fire”), the stored energy in the capacitors may be discharged through the light emitters 424. In some embodiments, the firing circuit 428 may cause the light emitters 424 to emit light signals simultaneously with one another. In other embodiments, the firing circuit 428 may cause the light emitters 424 to emit light signals sequentially. Other firing patterns (including random and pseudo-random firing patterns) are also possible and contemplated herein.

Additionally, in some embodiments, the firing circuit 428 may be controlled by a controller (e.g., the controller 416 illustrated and described with reference to FIG. 4B). The controller 416 may selectively fire the light emitters 424 using the firing circuit 428 via firing-control signals (e.g., according to a predefined pattern). In some embodiments, the controller 416 may also be configured to control other functions of the lidar device 410. For example, the controller may control the movement of one or more movable stages associated with the lidar device 410 and/or generate a point-cloud representation of the environment surrounding the lidar device 410 based on received electronic signals from light detectors 426 in the lidar device 410 that correspond to detected light signals reflected from objects in the environment. Generating the point-cloud representation may be done based on the intensity of the detected signal compared to the intensity of an emitted signal and/or based on the timing of the detected signal compared to the timing of an emitted signal, in various embodiments. In alternate embodiments, data about detected light signals and/or emitted light signals (e.g., timing data or intensity data) may be transmitted to a separate computing device (e.g., a remotely located server computing device or an on-board vehicle controller, such as system controller 402 illustrated and described with reference to FIG. 4A). The separate computing device may be configured to generate the point-cloud representation (e.g., and store the point-cloud representation in a memory, such as memory 406, and/or transmit the point-cloud representation to a lidar controller).

It is understood that the arrangement illustrated in FIG. 5 is provided as an example and that other embodiments are also possible and are contemplated herein. For example, a lidar device 410 may instead include multiple substrates 500, each having light emitters 424 and light detectors 426 thereon. Additionally or alternatively, in some embodiments, the number of light emitters 424 on the substrate 500 may be different than illustrated in FIG. 5, the number of light detectors 426 on the substrate 500 may be different than illustrated in FIG. 5, the arrangement of the light emitters 424 on the substrate 500 may be different than illustrated in FIG. 5, the arrangement of the light detectors 426 on the substrate 500 may be different than illustrated in FIG. 5, the position and/or number of conductive traces 502 may be different than illustrated in FIG. 5, the relative size of one or more of the light emitters 424 may be different than illustrated in FIG. 5, and/or the relative size of one or more of the light detectors 426 may be different than illustrated in FIG. 5. Other differences are also possible and are contemplated herein.

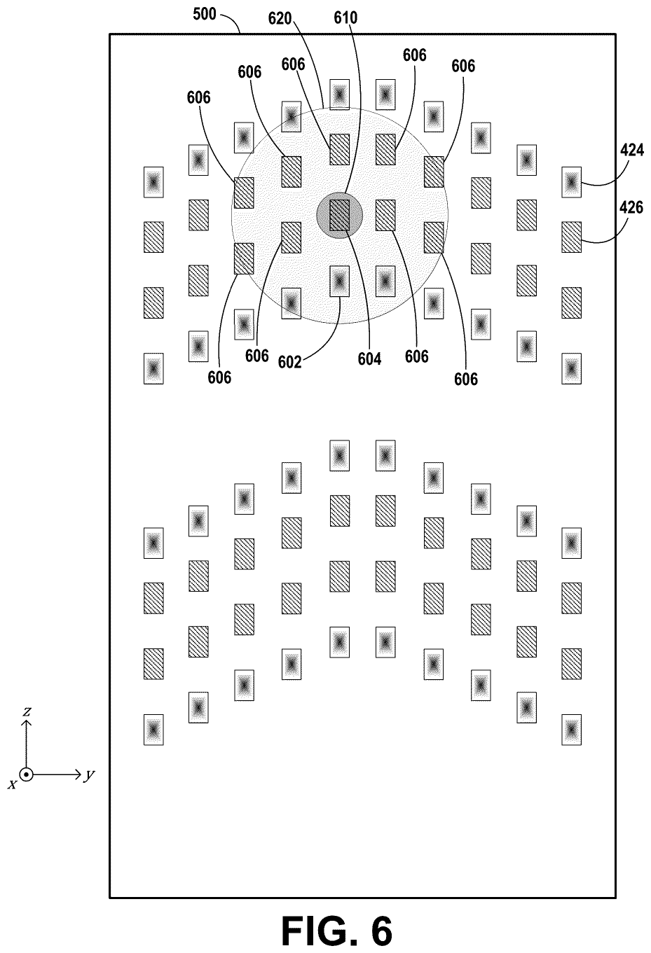

FIG. 6 is an illustration of crosstalk between channels within a lidar device (e.g., the lidar device 410 illustrated and described with reference to FIGS. 4A-5), according to example embodiments. For example, the lidar device 410 may include the substrate 500 and the array of channels (e.g., each channel including a light emitter 424 and a light detector 426, as illustrated in FIG. 5). While the lidar device 410 may also include the firing circuit 428, the selector circuit 430, and/or conductive traces 502, such components have been removed from the illustration of FIG. 6 to prevent cluttering of the drawing.

As an example, the lidar device may include a first light emitter 602. The first light emitter 602 may emit a light signal into a surrounding environment. Typically, upon the emitted light signal being reflected by a surface having a moderate reflectivity, a moderate-intensity reflected light signal 610 may be directed back to the lidar device. As illustrated in FIG. 6, the moderate-intensity reflected light signal 610 may illuminate a corresponding first light detector 604 within the lidar device. Further, the size of the moderate-intensity reflected light signal 610 may not be large enough to substantially and/or measureably illuminate other light detectors 426 within the lidar device. However, if the light signal emitted from the first light emitter 602 into the surrounding environment is reflected by a surface having a high reflectivity (e.g., a retroreflector), the intensity of the reflected signal may be higher and/or occupy a larger detectable area when incident on the array of light detectors 426. As illustrated in FIG. 6, a high-intensity reflected light signal 620 may illuminate a number of light detectors 426. For example, the high-intensity reflected light signal 620 may illuminate the first light detector 604 as well as a number of second light detectors 606. The second light detectors 606 may be referred to herein as light detectors susceptible to crosstalk (e.g., crosstalk from the reflected light signal resulting from the emission signal from the first light emitter 602) meaning that the second light detectors 606 may undesirably detect light from the first channel (e.g., which may result in noise or improper detection events based on the detections of the second light detectors 606).

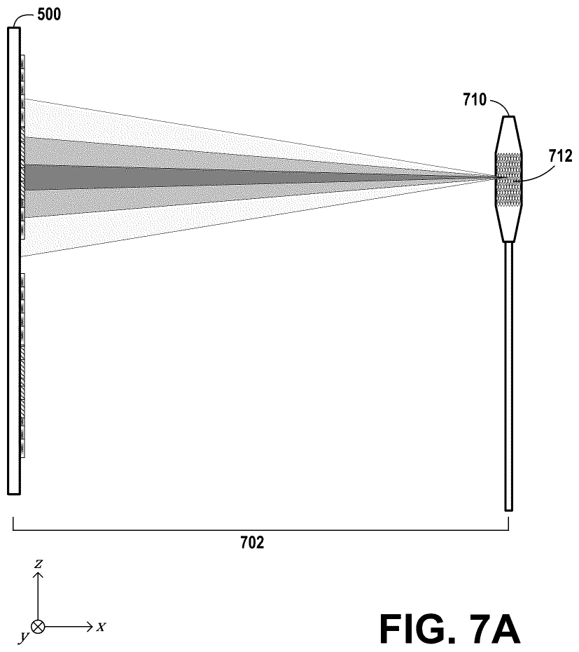

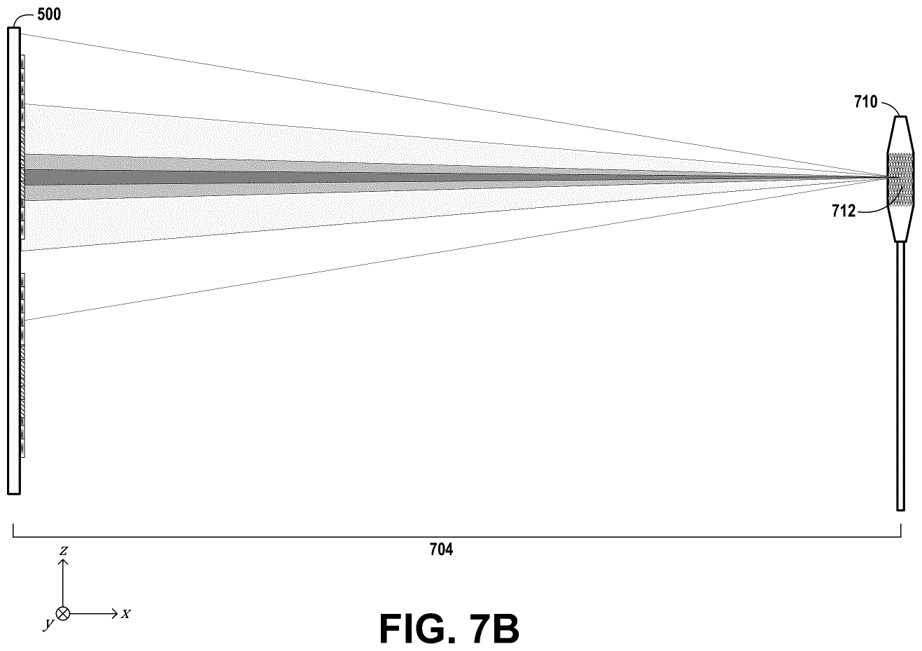

It is understood that which of the light detectors 426 within the lidar device can detect a given reflected signal (e.g., which light detectors 426 are susceptible to crosstalk) may depend on the intensity of the reflected signal (e.g., based on the reflectivity of the surface in the surrounding environment), the sensitivity of the light detectors 426, the location of the light detectors 426 in the lidar device, the orientation of the light detectors 426 in the lidar device (e.g., the azimuthal/yaw angular orientation and/or elevation/pitch angular orientation of the light detectors 426), the distance to the reflective surface in the surrounding environment, etc. As an example, FIGS. 7A and 7B illustrate an object 710 that includes a high-reflectivity surface 712 (e.g., a road sign that includes retroreflective lettering). In FIG. 7A, the high-reflectivity surface 712 is separated (e.g., along the x-direction, as illustrated) from the array of light emitters 424 and light detectors 426 by a first distance 702. In FIG. 7B, however, the high-reflectivity surface 712 is separated (e.g., along the x-direction, as illustrated) from the array of light emitters 424 and light detectors 426 by a second distance 704 (e.g., the second distance 704 being longer than the first distance 702). Because reflected light signals may attenuate/diverge as they propagate through the surrounding environment (e.g., because of dust, smoke, etc. in the surrounding environment), the intensity of a light signal may decrease the farther the separation between the lidar device and the high-reflectivity surface 712. As a result, the surface area of a region of the lidar device that experiences high intensity (and is thereby susceptible to crosstalk) as a result of the reflection from the high-reflectivity surface 712 may be larger the closer the lidar device is to the high-reflectivity surface 712. This is illustrated in FIGS. 7A and 7B by the high-intensity region of the reflected signal (signified by the darkest central cone of the reflected signal). The high-intensity region of the reflected signal may represent that portion of the signal that is detectable by the light detectors 426 (e.g., thereby giving rise to crosstalk). As illustrated, the cross-sectional area of the lidar device spanned by the high-intensity region of the reflected signal is larger in FIG. 7A (e.g., when the lidar device is separated from the high-reflectivity surface 712 by the first distance 702) than in FIG. 7B (e.g., when the lidar device is separated from the high-reflectivity surface 712 by the second distance 704).

Given the above, it is understood that in various embodiments reflected signals may be detected by unintended light detectors 426 in the lidar device 410, thereby resulting in crosstalk. Embodiments described herein may attempt to mitigate crosstalk within a lidar device 410, regardless of the cause (e.g., regardless if the crosstalk was caused by a high-reflectivity surface and/or, if the crosstalk was caused by a high-reflectivity surface, regardless of the separation between the lidar device 410 and the high-reflectivity surface).

In order to mitigate crosstalk within a lidar device 410, the lidar device 410 (e.g., a controller of the lidar device 410, such as the controller 416 illustrated in FIG. 4B) may first identify the possibility for crosstalk (e.g., by detecting the presence of a high-reflectivity surface in the surrounding environment). Identifying the possibility for crosstalk to be occurring may include detecting a reflected signal from the surrounding environment (e.g., in the regular course of emission/detection cycles to sense objects in the surrounding environment) that has a high intensity. For example, the lidar device 410 may compare the intensity of each detected reflected signal (e.g., based on the output electrical signal from the light detector 426 that detected the signal) to a threshold intensity. If the detected reflected signal exceeds the threshold, it may be determined that crosstalk as a result of an object in the surrounding environment (e.g., a high-reflectivity surface, such as a retroreflective surface) is possible.

Upon determining that crosstalk may be occurring in other channels in the lidar device 410 based on the detection of the high-intensity reflected signal from at least one channel, the lidar device 410 (e.g., the controller 416 of the lidar device 410) may then attempt to determine which of the other channels in the lidar device 410 may be susceptible to crosstalk from the channel that detected the high-intensity reflected signal. For example, the lidar device 410 may analyze one or more aspects of the detected high-intensity reflected signal and/or the locations of other light detectors 426 within the lidar device 410 to determine which of the other light detectors 426 within the lidar device 410 may be susceptible to crosstalk. In some embodiments, this may involve identifying (i) which of the other light detectors 426 are physically near the light detector 426 that detected the high-intensity reflected signal and (ii) the distance between the lidar device 410 and the high-reflectivity surface (e.g., based on the transit time of the high-intensity reflected signal). Based on this information, the controller 416 (e.g., the processor 418 of the controller 416) may access/review a lookup table (e.g., stored within an associated memory, such as the memory 420 illustrated in FIG. 4B) to determine which of the other channels/light detectors 426 are susceptible to crosstalk.

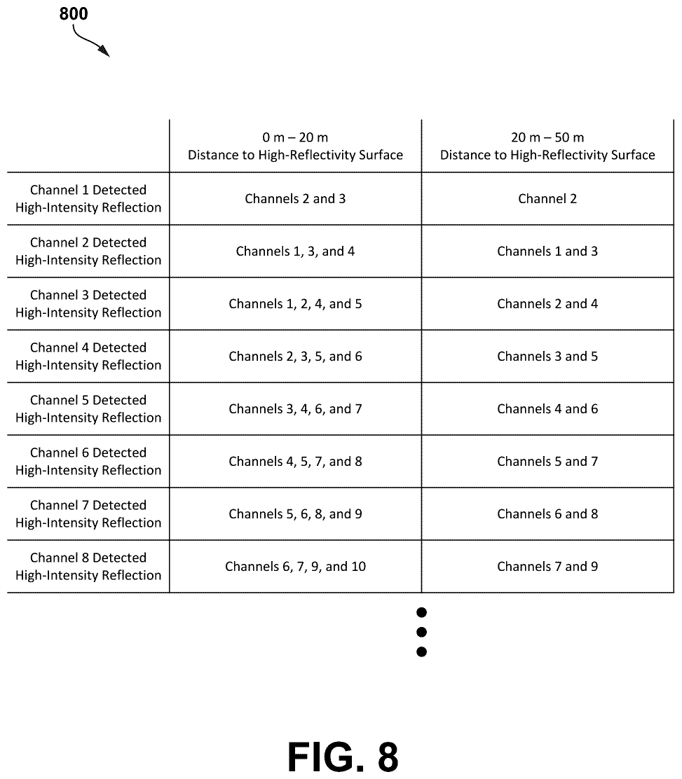

An example lookup table 800 is illustrated in FIG. 8. As illustrated, the lookup table 800 may include lists of channels that are susceptible to crosstalk based on a detected high-intensity reflected signal. Which channels are in a given list may be based on which channel detected the high-intensity reflected signal and the distance between the lidar device 410 and the corresponding high-reflectivity surface. For example, as illustrated in FIG. 8, if channel 4 detects a high-intensity reflected signal that corresponds to a high-reflectivity surface that is between 0 m and 20 m away from the lidar device 410, channels 2, 3, 5, and 6 (e.g., the light detectors 426 of channels 2, 3, 5, and 6) may be determined as being susceptible to crosstalk. Additionally, as illustrated in FIG. 8, if channel 4 detects a high-intensity reflected signal that corresponds to a high-reflectivity surface that is between 20 m and 50 m away from the lidar device 410, only channels 3 and 5 (e.g., the light detectors 426 of channels 3 and 5) may be determined as being susceptible to crosstalk (e.g., resulting from the difference in distance as illustrated and described with reference to FIGS. 7A and 7B). As another example, as illustrated in FIG. 8, if channel 1 detects a high-intensity reflected signal that corresponds to a high-reflectivity surface that is between 20 m and 50 m away from the lidar device 410, channel 2 (e.g., the light detector 426 of channel 2) may be determined as being susceptible to crosstalk. Other example sets of channels are also illustrated in the lookup table 800 of FIG. 8.

The lookup table 800 may be generated prior to when the lidar device 410 is being used to detect objects in the surrounding environment, in some embodiments. For example, the lookup table 800 may have been previously generated by the controller 416 (e.g., the processor 418 of the controller 416) and stored within a memory (e.g., the memory 420). Alternatively, the lookup table 800 may have been generated by the system controller 402 (e.g., the processor 404 of the system controller 402) and transmitted to lidar device 410 for use by the lidar device 410 in runtime. In still other embodiments, the lookup table 800 may have been generated by a different computing device (e.g., a computing device associated with a fabrication method used to fabricate the lidar device 410) and stored within the lidar device 410 (e.g., within the memory 420 of the lidar device 410) for later use.

Further, the lookup table 800 may have been generated based on the locations of the light detectors 426 relative to one another in the lidar device 410. For example, a layout/map of the locations of the light detectors 426 in the lidar device 410 may be generated. Then, based on the layout/map, an identification of which other light detectors 426 are within a given distance of each light detector 426 (e.g., within a given radius of the respective light detector 426 on the substrate 500) may be made. For example, a first light detector 426 in the lidar device 410 may be selected, and a determination of which other light detectors 426 are within a first distance (e.g., 0.1 cm, 0.5 cm, 1.0 cm, 2.0 cm, 3.0 cm, 4.0 cm, 5.0 cm, 10.0 cm, etc.) may be made. Further, a determination of which other light detectors 426 are within a second distance (e.g., 0.5 times the first distance, 0.333 times the first distance, 0.25 times the first distance, 0.1 times the first distance, etc.) may then be made. Then, those light detectors 426 that are within the first distance of the first light detector 426 may be stored in the lookup table 800 as a list of light detectors 426 that are susceptible to crosstalk when a high-reflectivity surface is located in a first range of distances (e.g., between 0 m and 10 m, between 0 m and 15 m, between 0 m and 20 m, between 0 m and 25 m, between 0 m and 30 m, etc.). Further, those light detectors 426 that are within the second distance of the first light detector 426 may be stored in the lookup table 800 as a list of light detectors 426 that are susceptible to crosstalk when a high-reflectivity surface is located in a second range of distances (e.g., between 10 m and 50 m, between 15 m and 50 m, between 20 m and 50 m, between 25 m and 50 m, between 30 m and 50 m, etc.). This process of identifying sets of light detectors 426 that are within given distances of a selected light detector 426 may then be repeated for each light detector 426 in the lidar device 410 to generate the full lookup table 800.

It is understood that the lookup table 800 of FIG. 8 and the above-described method of generating the lookup table 800 are provided solely as examples and that other embodiments are also possible and are contemplated herein. For instance, in some embodiments, the lookup table 800 may: include more than two columns to provide additional granularity regarding distance to the high-reflectivity surface, include only a single column, include more or fewer rows than illustrated in FIG. 8 (e.g., represented by the vertical dots of FIG. 8) based on how many light detectors 426 are in the lidar device 410, may include more or fewer light detectors 426 in each list of light detectors 426 susceptible to crosstalk based on the spacing of/arrangement of the light detectors 426 within the lidar device 410, etc. For example, the arrangement of FIG. 5 includes forty light detectors 426, so a lookup table corresponding to the lidar device 410 of FIG. 5 may include forty rows.

Additionally or alternatively, the lookup table 800 may include different distance ranges than those described herein and/or a distance range that represents anything beyond a predetermined threshold. For example, in some embodiments, the lookup table 800 may include a third column that represents distances to the high-reflectivity surface that are greater than 50 m. Still further, in some embodiments, the lookup table 800 may be generated by taking one or more calibration measurements using the lidar device 410 (e.g., to determine which light detectors 426 actually experience crosstalk for different distances to high-reflectivity surfaces) and storing the results of those calibration measurements in the lookup table 800.

It is understood that, in some embodiments, additional or alternative factors may be considered when determining which of the remaining light detectors 426 are susceptible to crosstalk (e.g., in addition to or instead of (i) which of the other light detectors 426 are physically near the light detector that detected the high-intensity reflected signal and (ii) the distance between the lidar device 410 and the high-reflectivity surface). For example, the intensity of the high-intensity reflected signal, the wavelength of the high-intensity reflected signal (e.g., in embodiments where at least some of the channels use different wavelength ranges to isolate the channels from one another), the polarization of the high-intensity reflected signal (e.g., in embodiments where at least some of the channels use different polarizations to isolate the channels from one another), the angular orientation (e.g., in azimuth/yaw and/or elevation/pitch) of the other light detectors 426, etc. may also be considered. Such additional or alternative factors may likewise be incorporated into the lookup table 800, in some embodiments.

Upon detecting a high-intensity reflected signal and determining which channels (e.g., which light detectors 426) may be susceptible to crosstalk (e.g., using the lookup table 800), a controller 416 may then analyze the signals detected by the light detectors 426 determined as being susceptible to crosstalk. For example, the controller 416 (e.g., a processor 418 of the controller 416) may analyze the detection sequences of each of the light detectors 426 susceptible to crosstalk to determine whether any crosstalk detection events are actually present in those detection sequences. Determining whether any crosstalk detection events are present in the detection sequences may include disambiguating detections within the detection sequences that represent detection events corresponding to light emitted by the light emitter 424 of the respective channel from those detection events that represent crosstalk. One technique for doing so includes identifying the transit time associated with the given detection event. If the transit time associated with the detection event would correspond to a distance that is similar to the distance to the high-reflectivity surface (e.g., within a threshold difference from the distance to the high-reflectivity surface, such as within 1 cm, 10 cm, 20 cm, 30 cm, 50 cm, 1 m, etc.) previously determined by the controller 416, it may be determined that such a detection event represents crosstalk. If, however, the detection event has a transit time that would correspond to a distance that is different from the distance to the high-reflectivity surface (e.g., outside of a threshold difference from the distance to the high-reflectivity surface), it may be determined that such a detection event does not represent crosstalk.

Other techniques may additionally or alternatively be used to disambiguate crosstalk detections from non-crosstalk detections in light detectors 426 that are identified as being susceptible to crosstalk. For example, a specific sequence of light signals (e.g., series of light pulses according to a predefined firing sequence/modulation scheme) may be emitted by the light emitter 424 that corresponds to the light detector 426 that originally detected the high-intensity reflected signal (e.g., the light emitter 424 that is the putative cause of the crosstalk). Such a specified sequence may be emitted by the light emitter 424 that is the putative cause of the crosstalk in runtime (e.g., to continue to detect objects using the channel that is the putative cause of the crosstalk) or separately (e.g., between emissions used for detecting objects) in order to confirm crosstalk.

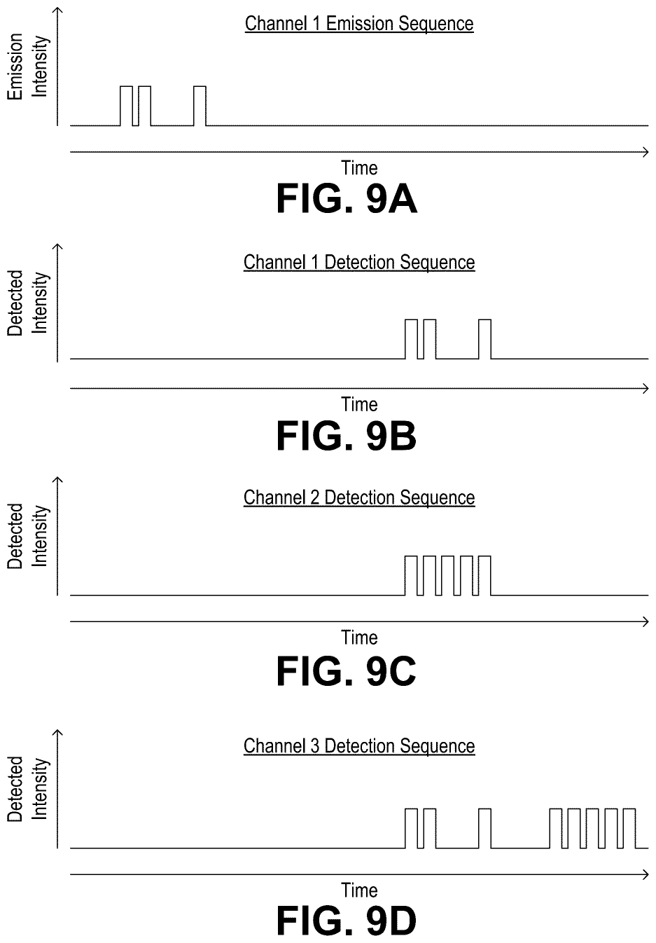

FIGS. 9A-9D illustrate how such a technique could be used to identify crosstalk within light detectors 426 identified by the controller 416 as being susceptible to crosstalk. For example, FIG. 9A illustrates an emission sequence/modulation sequence that may be emitted by the light emitter 424 in the channel putatively responsible for the crosstalk (e.g., the light emitter 424 in channel 1 in the illustration of FIG. 9A). The emission sequence may be randomly or pseudo-randomly generated or may be predefined and stored within a memory 420 of the controller 416 of the lidar device 410. Further, the emission sequence employed with each light emitter 424 when such a light emitter 424 is determined to be putatively causing crosstalk may be the same or different across the light emitters 424. The emission sequence of FIG. 9A may include an emission during a first emission window, an emission during a second emission window, no emission during a third emission window, no emission during a fourth emission window, and emission during a fifth emission window, for example. It is understood that the specific emission sequence of FIG. 9A is provided solely as an example and that other emission sequences are also possible and are contemplated herein. While emitting the emission sequence of FIG. 9A using the light emitter 424 in the channel putatively responsible for the crosstalk, the remaining light emitters 424 may emit a standard emission sequence that is different from the emission sequence illustrated in FIG. 9A. For example, the emission sequence of the remaining light emitters 424 may emit with an emission sequence that would typically be used when detecting objects in the surrounding environment (e.g., emitting during each emission window in the five emission window sequence, unlike the emission sequence illustrated in FIG. 9A).

While the emission sequence illustrated in FIG. 9A represents a time modulation (e.g., a modification of the time windows in which the light emitter 424 in channel 1 fires a pulse and in which the light emitter 424 in channel 1 refrains from firing a pulse), it is understood that other types of modulation could also be used to identify crosstalk. For example, the emitted wavelength, the emitted polarization, and/or the emitted intensity could also be modulated. Such modulations could be performed within the light emitters 424, themselves, and/or using associated modulation optics (e.g., lenses, chromatic filters, polarizers, neutral-density filters, etc.).

FIGS. 9B-9D illustrate detection sequences that are detected based on the emission period of FIG. 9A. As illustrated in FIG. 9B, the detection sequence detected by the light detector 426 of channel 1 (e.g., the channel putatively responsible for causing the crosstalk) has the same pattern as the emission sequence of FIG. 9A. This is expected as the light detector 426 of channel 1 corresponds to the light emitter 424 of channel 1.

FIG. 9C illustrates the detection sequence detected by the light detector 426 of channel 2. As illustrated, the detection sequence does not match (e.g., the pattern does not match) the emission sequence of FIG. 9A (e.g., and, similarly, does not match the detection sequence of FIG. 9B). As such, the detection events from the light detector 426 of channel 2 may be determined not to represent crosstalk.

FIG. 9D illustrates the detection sequence detected by the light detector 426 of channel 3. As illustrated, a portion of the detection sequence matches (e.g., the pattern does match) the emission sequence of FIG. 9A (e.g., and, similarly, matches the detection sequence of FIG. 9B). For example, the first portion of the detection sequence illustrated in FIG. 9D matches the detection sequence of FIG. 9B (e.g., both in pattern and in relative position in time/corresponding distance to the object in the surrounding environment). Further, the second portion of the detection sequence illustrated in FIG. 9D may not have the same relative position in time/pattern associated with the detection sequence of FIG. 9B. As such, the controller 416 may determine that the first portion of the detection sequence detected by the light detector 426 of channel 3 represents unintended crosstalk (and should therefore be removed), while the second portion of the detection sequence detected by the light detector 426 of channel 3 represents a proper measurement of objects in the surrounding environment. While the detection sequence of FIG. 9D includes both a crosstalk portion and a non-crosstalk portion, it is understood that this is provided solely as an example and that, in other embodiments, other detection sequences are also possible. For example, in some cases, a detection sequence may only include one portion and that portion may correspond to crosstalk (e.g., meaning that the entire detection sequence represents crosstalk and should be discarded).

Upon identifying crosstalk detections, regardless of the technique used to identify crosstalk (e.g., determining based on a comparison to predefined firing sequence emitted by the light emitter 424 putatively causing the crosstalk or based on detection events by light detectors 426 susceptible to crosstalk that correspond to a specific distance), the controller 416 may preventing the crosstalk detections from being included in a dataset that describes the surrounding environment (e.g., a dataset usable to generate a point cloud or map of the surrounding environment). If the controller 416, itself, generates point clouds, this may include preventing improper data points that correspond to the crosstalk detections from being included in the point cloud and/or removing improper data points that correspond to the crosstalk detections from the point cloud if they have already been included in the point cloud. Additionally or alternatively, preventing the crosstalk detections from being included in a dataset that describes the surrounding environment may include removing the crosstalk detections from a datastream prior to transmitting the datastream to another device (e.g., the system controller 402). This may prevent the device that receives the datastream from storing the improper crosstalk detections and/or using the improper crosstalk detections to generate a point cloud of the surrounding environment.

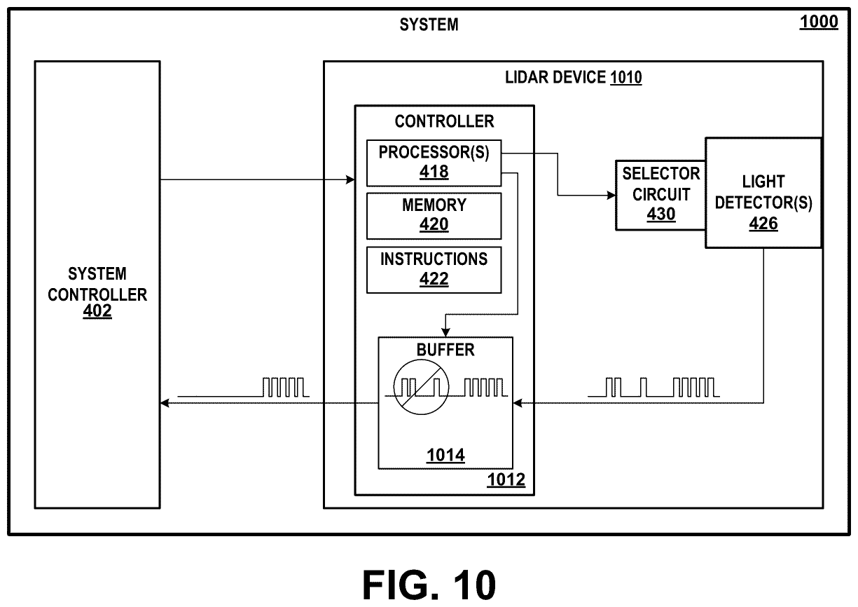

For example, FIG. 10 is an illustration of a technique for preventing one or more crosstalk pulses from being included in a dataset usable to generate a point cloud, according to example embodiments. As illustrated, FIG. 10 may be performed by a system 1000. The system 1000 may be similar to the system 400 illustrated in FIG. 4A. For example, the system 1000 may include a system controller (e.g., the system controller 402 illustrated in FIG. 4A) and a lidar device 1010. Further, though not illustrated, the system 1000 may also include sensors 412 and/or controllable components 414, in some embodiments. As also illustrated in FIG. 10, the lidar device 1010 may include a controller 1012, a selector circuit (e.g., the selector circuit 430 shown and described with reference to FIG. 4B), and light detector(s) (e.g., the light detector(s) shown and described with reference to FIG. 4B). Though not illustrated, in some embodiments the lidar device 1010 may also include light emitters (e.g., the light emitters 424 illustrated in FIG. 4B) and a firing circuit (e.g., the firing circuit 428 illustrated in FIG. 4B).

The controller 1012 may include processor(s) (e.g., the processor(s) 418 shown and described with reference to FIG. 4B), a memory (e.g., the memory 420 shown and described with reference to FIG. 4B), instructions (e.g., the instructions 422 shown and described with reference to FIG. 4B), and a buffer 1014. In some embodiments, for example, the controller 1012 may be implemented as or include an FPGA, an ASIC, or one or more processors. The buffer 1014 may include one or more volatile memories (e.g., one or more RAMs, such as one or more RAM elements communicatively coupled to the FPGA). In some embodiments, the buffer 1014 may be integrated within the memory 420 or within the processor 418. Other examples of the buffer 1014 are also possible and are contemplated herein.

As illustrated in FIG. 10 by the arrow, the processor 418 may access and/or provide instructions to the buffer 1014. For example, in some embodiments, the processor 418 may be able to write data to the buffer 1014, read data from the buffer 1014, and/or delete data from the buffer 1014. As also illustrated, the buffer 1014 may store detection events (e.g., electrical signals from the light detector(s) 426 that represent detection events). The detection events may be transferred from the light detector(s) 426 to the controller 1012 (e.g., to the processor(s) 418 of the controller 1012) and then temporarily stored within the buffer 1014. As such, the buffer 1014 may be sized so as to store a sufficient number of detection events. For example, the buffer 1014 may be large enough to temporarily store one, two, three, four, five, etc. detection events. In some embodiments, the buffer 1014 may have sufficient storage so as to at least store a number of detected pulses from the light detector(s) 426 that is equal to the number of pulses in a predefined firing sequence. For example, the buffer 1014 may have enough storage to temporarily store the number of pulses of the emission sequence/modulation sequence emitted by a light emitter in a channel putatively responsible for crosstalk (e.g., the emission sequence/modulation sequence of FIG. 9A) in order to detect crosstalk in nearby channels. In some embodiments, the buffer 1014 may be even larger (e.g., large enough to store both an emission sequence/modulation sequence usable to identify crosstalk and additional data corresponding to actual detection events within a given channel).

As described above, once one or more detection events are determined to represent crosstalk, those detection event(s) may be removed from a dataset. As illustrated in FIG. 10, the buffer 1014 may initially store a set of detection events. For example, the buffer 1014 may store a series of detection events corresponding to the detection events of channel 3 as illustrated in FIG. 9D. Upon the controller 1012 (e.g., the processor(s) 418 of the controller 1012) determining that a portion (e.g., the entirety) of the detection events temporarily stored within the buffer 1014 represent crosstalk, the processor(s) 418 may cause that portion of the detection events to be deleted from the buffer 1014. This is illustrated in FIG. 10 by the circle with the line through it over the portion of the detection events corresponding to crosstalk (e.g., based on FIG. 9D). After removing the crosstalk data from the dataset, the dataset may then be transmitted on to another device. For example, as illustrated in FIG. 10, the dataset may be transmitted from the buffer 1014 to the system controller 402 (e.g., the system controller 402 may then read data from the buffer 1014). The system controller 402 may then store the detection event(s), transmit the detection event(s) to an additional device, and/or transform the dataset into a different form (e.g., use the detection event(s) to form a point cloud representing the surrounding environment). It is understood that the technique for preventing one or more crosstalk pulses from being included in a dataset usable to generate a point cloud illustrated in FIG. 10 is provided solely as an example. Other techniques for removing crosstalk data from a dataset are also possible and are contemplated herein.

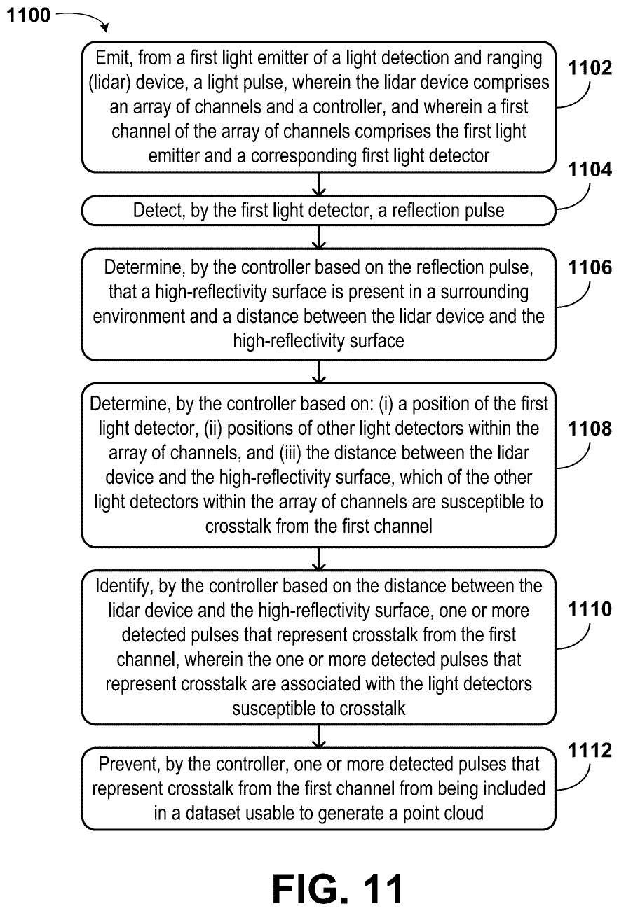

FIG. 11 is a flowchart diagram of a method 1100, according to example embodiments. In some embodiments, the method 1100 may be performed to mitigate crosstalk from neighboring channels within a lidar device. In some embodiments, the method 1100 may be performed by a system (e.g., the system 1000 illustrated in FIG. 10) that includes a lidar device (e.g., the lidar device 410 illustrated in FIG. 10).

At block 1102, the method 1100 may include emitting, from a first light emitter of a lidar device, a light pulse. The lidar device may include an array of channels and a controller. The first channel of the array of channels may include the first light emitter and a corresponding first light detector.

At block 1104, the method 1100 may include detecting, by the first light detector, a reflection pulse.

At block 1106, the method 1100 may include determining, by the controller based on the reflection pulse, that a high-reflectivity surface is present in a surrounding environment and a distance between the lidar device and the high-reflectivity surface.

At block 1108, the method 1100 may include determining, by the controller based on: (i) a position of the first light detector, (ii) positions of other light detectors within the array of channels, and (iii) the distance between the lidar device and the high-reflectivity surface, which of the other light detectors within the array of channels are susceptible to crosstalk from the first channel.

At block 1110, the method 1100 may include identifying, by the controller based on the distance between the lidar device and the high-reflectivity surface, one or more detected pulses that represent crosstalk from the first channel. The one or more detected pulses that represent crosstalk may be associated with the light detectors susceptible to crosstalk.

At block 1112, the method 1100 may include preventing, by the controller, one or more detected pulses that represent crosstalk from the first channel from being included in a dataset usable to generate a point cloud.

In some embodiments of the method 1100, block 1108 may include accessing a lookup table. Such a lookup table may store, for example, a list of which of the light detectors are susceptible to crosstalk for a plurality of combinations of: (i) distances between the lidar device and the high-reflectivity surface and (ii) light detectors detecting reflection pulses that correspond to a high-reflectivity surface.

In some embodiments, the method 1100 may also include emitting, by the first light emitter, a series of light pulses according to a predefined firing sequence. The one or more detected pulses that represent crosstalk may be identified based on the predefined firing sequence. Further, emitting the series of light pulses according to the predefined firing sequence may include emitting a first predefined number of emission pulses. Yet further, in some embodiments, the method 1100 may also include buffering, within a memory of the controller, a series of detected pulses for each light detector susceptible to crosstalk. The memory may have sufficient storage so as to store a number of detected pulses in the series of detected pulses for each light detector susceptible to crosstalk when the number of detected pulses is equal to the first predefined number. Even further, in some embodiments, preventing the one or more detected pulses that represent crosstalk from the first channel from being included in the dataset usable to generate a point cloud may include removing, from the memory, those detected pulses buffered within the memory that represent crosstalk.

In some embodiments, the method 1100 may also include generating, by the controller, a point cloud using detected pulses detected by the light detectors.

In some embodiments of the method 1100, the high-reflectivity surface may include a surface of a retroreflective object.

In some embodiments of the method 1100, which of the other light detectors within the array of channels are susceptible to crosstalk from the first channel may further be determined based on a pitch angle of and a yaw angle of an emission vector associated with a first emitter of the first channel.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flow charts in the figures and as discussed herein, each step, block, operation, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step, block, or operation that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer-readable medium such as a storage device including RAM, a disk drive, a solid state drive, or another storage medium.

Moreover, a step, block, or operation that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A light detection and ranging (lidar) device comprising:
an array of channels, wherein each channel comprises a light detector and a corresponding light emitter; and
a controller, wherein the controller is configured to:
cause one or more of the light emitters in the array of channels to emit light pulses;
determine, based on a reflection pulse detected by a first light detector of a first channel in the array of channels, that a high-reflectivity surface is present in a surrounding environment and a distance between the lidar device and the high-reflectivity surface;
determine, based on: (i) a position of the first light detector, (ii) positions of other light detectors within the array of channels, and (iii) the distance between the lidar device and the high-reflectivity surface, which of the other light detectors within the array of channels are susceptible to crosstalk from the first channel;
identify one or more detected pulses that represent crosstalk from the first channel, wherein the one or more detected pulses that represent crosstalk are associated with the light detectors susceptible to crosstalk and are identified based on the distance between the lidar device and the high-reflectivity surface; and
prevent the one or more detected pulses that represent crosstalk from the first channel from being included in a dataset usable to generate a point cloud.

2. The lidar device of claim 1, wherein determining which of the other light detectors within the array of channels are susceptible to crosstalk comprises accessing a lookup table, and wherein the lookup table stores a list of which of the light detectors are susceptible to crosstalk for a plurality of combinations of: (i) distances between the lidar device and the high-reflectivity surface and (ii) light detectors detecting reflection pulses that correspond to a high-reflectivity surface.

3. The lidar device of claim 1, wherein the controller is further configured to cause a first light emitter of the first channel to emit a series of light pulses according to a predefined firing sequence, and wherein the one or more detected pulses that represent crosstalk are identified based on the predefined firing sequence.

4. The lidar device of claim 3, wherein the series of light pulses emitted according to the predefined firing sequence comprises a first predefined number of emission pulses, wherein the controller comprises a memory, wherein the controller is further configured to buffer, within the memory, a series of detected pulses for each light detector susceptible to crosstalk, and wherein the memory has sufficient storage so as to store a number of detected pulses in the series of detected pulses for each light detector susceptible to crosstalk when the number detected pulses is equal to the first predefined number.

5. The lidar device of claim 4, wherein preventing the one or more detected pulses that represent crosstalk from the first channel from being included in the dataset usable to generate a point cloud comprises removing, from the memory, those detected pulses buffered within the memory that represent crosstalk.

6. The lidar device of claim 4, wherein the controller comprises an field-programmable gate array (FPGA), and wherein the memory comprises a random-access memory (RAM) communicatively coupled to the FPGA.

7. The lidar device of claim 1, wherein the controller is further configured to generate a point cloud using detected pulses detected by the light detectors.

8. The lidar device of claim 1, wherein the high-reflectivity surface comprises a surface of a retroreflective object.

9. The lidar device of claim 1, wherein which of the other light detectors within the array of channels are susceptible to crosstalk from the first channel is further determined based on a pitch angle of and a yaw angle of an emission vector associated with a first emitter of the first channel.

10. The lidar device of claim 1, wherein determining that the high-reflectivity surface is present in the surrounding environment comprises comparing an intensity of the reflection pulse detected by the first light detector to a threshold intensity.

11. A method comprising:
emitting, from a first light emitter of a light detection and ranging (lidar) device, a light pulse, wherein the lidar device comprises an array of channels and a controller, and wherein a first channel of the array of channels comprises the first light emitter and a corresponding first light detector;
detecting, by the first light detector, a reflection pulse;
determining, by the controller based on the reflection pulse, that a high-reflectivity surface is present in a surrounding environment and a distance between the lidar device and the high-reflectivity surface;
determining, by the controller based on: (i) a position of the first light detector, (ii) positions of other light detectors within the array of channels, and (iii) the distance between the lidar device and the high-reflectivity surface, which of the other light detectors within the array of channels are susceptible to crosstalk from the first channel;
identifying, by the controller based on the distance between the lidar device and the high-reflectivity surface, one or more detected pulses that represent crosstalk from the first channel, wherein the one or more detected pulses that represent crosstalk are associated with the light detectors susceptible to crosstalk; and
preventing, by the controller, one or more detected pulses that represent crosstalk from the first channel from being included in a dataset usable to generate a point cloud.

12. The method of claim 11, wherein determining which of the other light detectors within the array of channels are susceptible to crosstalk comprises accessing a lookup table, and wherein the lookup table stores a list of which of the light detectors are susceptible to crosstalk for a plurality of combinations of: (i) distances between the lidar device and the high-reflectivity surface and (ii) light detectors detecting reflection pulses that correspond to a high-reflectivity surface.

13. The method of claim 11, further comprising emitting, by the first light emitter, a series of light pulses according to a predefined firing sequence, wherein the one or more detected pulses that represent crosstalk are identified based on the predefined firing sequence.

14. The method of claim 13, wherein emitting the series of light pulses according to the predefined firing sequence comprises emitting a first predefined number of emission pulses, wherein the method further comprises buffering, within a memory of the controller, a series of detected pulses for each light detector susceptible to crosstalk, and wherein the memory has sufficient storage so as to store a number of detected pulses in the series of detected pulses for each light detector susceptible to crosstalk when the number of detected pulses is equal to the first predefined number.

15. The method of claim 14, wherein preventing the one or more detected pulses that represent crosstalk from the first channel from being included in the dataset usable to generate a point cloud comprises removing, from the memory, those detected pulses buffered within the memory that represent crosstalk.

16. The method of claim 11, further comprising generating, by the controller, a point cloud using detected pulses detected by the light detectors.

17. The method of claim 11, wherein the high-reflectivity surface comprises a surface of a retroreflective object.

18. The method of claim 11, wherein which of the other light detectors within the array of channels are susceptible to crosstalk from the first channel is further determined based on a pitch angle of and a yaw angle of an emission vector associated with a first emitter of the first channel.

19. A system comprising:
a computing device configured to generate a point cloud from a dataset usable to generate the point cloud; and
a light detection and ranging (lidar) device comprising:
an array of channels, wherein each channel comprises a light detector and a corresponding light emitter; and
a controller, wherein the controller is configured to:
cause one or more of the light emitters in the array of channels to emit light pulses;
determine, based on a reflection pulse detected by a first light detector of a first channel in the array of channels, that a high-reflectivity surface is present in a surrounding environment and a distance between the lidar device and the high-reflectivity surface;
determine, based on: (i) a position of the first light detector, (ii) positions of other light detectors within the array of channels, and (iii) the distance between the lidar device and the high-reflectivity surface, which of the other light detectors within the array of channels are susceptible to crosstalk from the first channel;
identify one or more detected pulses that represent crosstalk from the first channel, wherein the one or more detected pulses that represent crosstalk are associated with the light detectors susceptible to crosstalk and are identified based on the distance between the lidar device and the high-reflectivity surface;
prevent the one or more detected pulses that represent crosstalk from the first channel from being included in the dataset usable to generate the point cloud; and
transmit, to the computing device, the dataset usable to generate the point cloud.

20. The system of claim 19, wherein transmitting, to the computing device, the dataset usable to generate the point cloud comprises transmitting a datastream to the computing device, and wherein preventing the one or more detected pulses that represent crosstalk from the first channel from being included in the dataset usable to generate the point cloud comprises removing the one or more detected pulses from the datastream.
